(19) United States
(12) Patent Application Publication
(10) Pub. No.: US 2014/0027271 A1
(43) Pub. Date: Jan. 30, 2014

(54) Electrocoagulation for treating liquids

(71) Applicant: e2metrix inc., Sherbrooke (CA)

(72) Inventors: Abderrazak BERRAK, Sherbrooke (CA); Mathieu Filion, Sherbrooke (CA); Abdelaziz Bourega, Sherbrooke (CA); Mohamed Laaroussi, Orford (CA)

(73) Assignee: e2metrix inc., Sherbrooke (CA)

(21) Appl. No.: 14/041,942

(22) Filed: Sep. 30, 2013

Related U.S. Application Data
(63) Continuation-in-part of application No. 13/310,106, filed on Dec. 2, 2011.

(51) Int. Cl. C02F 1/461

(52) U.S. Cl. CPC C02F 1/46109
USPC 204/225; 29/428; 29/426.2

(57) ABSTRACT

A method, a system and a kit for removing colloid contaminants from a fluid or suspension by destabilization thereof with addition of kinetic energy thereto are provided, the method to overcome the energetic barrier preventing an efficient fluid-solid separation comprises injecting the colloidal fluid containing contaminants in an electrolytic system including an electrocoagulation module comprising at least one anode and at least one cathode, the anode and the cathode being adapted to be electrically connected to perform electrolysis of the fluid, providing an electric current, between the anode and the cathode, to form electro-coagulated contaminants flocs in the agitated fluid, separating the electro-coagulated flocs from the fluid, and extracting the fluid from the electrolytic system.

### CROSS-REFERENCE TO RELATED APPLICATIONS

The present patent application is a continuation-in-part of U.S. patent application Ser. No. 13/310,106 entitled ELECTROCOAGULATION FOR TREATING LIQUIDS, which is hereby incorporated by reference in its entirety.

### FIELD OF THE INVENTION

This invention relates to a method for treating liquid with electrocoagulation. More precisely, the present invention relates to a method, a system and an apparatus for treating colloidal solutions with electrocoagulation.

### BACKGROUND OF THE INVENTION

Nowadays water pollution is a significant issue and efforts are made to improve wastewater treatments. Water treatment processes commonly used are mainly based mechanical filtration and on bacterial activity. Many microorganisms belonging to five different classes (e.g. bacteria, virus, protozoa, fungi and helminth) are found in wastewater and wastewater process treatments. Disinfection processes are divided into two main groups, namely the physical and chemical processes (Metcalf and Eddy, 2003). The physical processes include: electromagnetic radiation, ultrasonic waves, heat, visible light and ultraviolet (UV), ionizing radiation (gamma and X), electron beam and electric current. Chemical methods use different compounds including: halogens and their derivatives (Cl₂, Br₂, I₂, HOCl, OCl, ClO₂, HOBr, HOI, etc.), oxygenated compounds and highly oxidizing (ozone, hydrogen peroxide, phenols, alcohols, percarbonates and persulfates, peracetic acid, potassium permanganate, etc.), dyes, quaternary ammonium compounds, acids and bases as well as enzymes. Some contaminants, like colloidal contaminants, are difficult to separate from liquid because of their electrical barrier.

Electrocoagulation was already proposed in the late 19th and early 20th century. The use of electrocoagulation with aluminum and iron was patented in 1909 in the United States (Stuart, 1947; Bonilla, 1947, Vik et al. 1984). Matteson et al. (1995) described an “electronic coagulator” in the 1940s, using aluminum anodes, and in 1956 a similar process in Great Britain using, in turn, iron anodes.

Coagulation is essentially to neutralize, or reduce, the electric charge of colloids and hence promote the aggregation of colloidal particles. To destabilize a suspension it is necessary that the attractive forces between particles are greater than the repulsive forces thereof. Attractive forces are mainly van der Waals forces, which act at a short distance thereof. In general, the total energy that controls the stability of the energy dispersion comprises attractive van der Waals energy of repulsion at short distance, the electrostatic energy and energy due to the steric effect of molecules solvent.

Coagulation can be done by chemical or electrical means. Alun, lime and/or polymers have been used as chemical coagulants. Chemical coagulation is becoming less popular today because of high costs associated with the chemical treatments of a significant volume of sludge and hazardous heavy metals such as metal hydroxides generated thereof in addition to the cost of chemical products needed for coagulation itself. Chemical coagulation has been used for decades.

Although the electrocoagulation mechanism resembles chemical coagulation, some differences benefit electrocoagulation. Indeed, electrocoagulated flocs differ from those generated by chemical coagulation. Flocs created with the electrocoagulation process tend to contain less bound water, are more resistant to shearing and are more easily filterable.

Flocs are created during the electrocoagulation water treatment with oxydo-reduction reactions. Currents of ions and charged particles, created by the electric field, increase the probability of collisions between ions and particles of opposite signs that migrate in opposite directions. This phenomenon allows the aggregation of suspended solids to form flocs.

The electrolytic reactions that take place at the electrodes are accompanied by production of micro bubbles of hydrogen (at the cathode) and oxygen (at the anode). These micro bubbles heading up will result in an upward movement of the flocs formed thereof that are recovered at the surface (this mechanism is named flotation).

The complexity of the mechanisms involved in the process of electrocoagulation in the treatment of water is not well scientifically elucidated (Yusuf et al., 2001). There are various features of the mechanism of the process and the geometry, or design, of the reactor in the literature. The different physico-chemical treatment, the shape of the reactor and the shape and size of electrodes affect the performance of the treatment (M. Bennajah, 2007). The wide variety of processing parameters reported in the literature and the lack of scientific data for efficient model processing and optimal processing conditions translate into a lack of development in this field. At this time, electrocoagulation is still problematic and therefore not popular (Holt et al. 2002, 2006).

The existence of an electric current in a body of water implicitly requires Faraday reactions surrounding the electrodes. The formation of chemical gradients depends on the electrolysis magnitude. The consequences of chemical reactions become more pronounced and significant in the prolonged application of electrokinetic. The effects include electrolysis of water with the simultaneous development of pH gradients and the transfer of electrolytic dissolution of the anode producing metal ions (Fe3+, Al3+, Mg2+, etc.) or cations of the electrolyte from the anode to the cathode. Chemical reactions can, in ion exchange or precipitation, form new mineral phases for cleaning water for instance.

At the cathode, the main reaction is:

4H₂O+4e⁻→2H₂+4OH⁻ (Equation 1)

The increase in hydroxyl ions can increase the precipitation of metal hydroxide. The pH of the cathode's region is basic. The following equations describe the chemical reactions at the anode:

2H₂O→O₂+4H⁺+4e⁻ (Equation 2)

If the anode is made of magnesium:

Mg→Mg²⁺+2e⁻ (Equation 3)

Legacy electrocoagulation systems are associated with several issues. One of the issues is related to gas accumulation that damages the recipient. Other issues can include a wrong alignment and distance between the electrodes, the use of wrong electrode materials, a wrong electrode geometry, the thickness of the electrodes is not proper and the amount of energy used is not suited for the treatment of a specific fluid. Also, legacy electrocoagulation systems are not convenient for commercial or industrial uses.

Therefore, there exists a need in the art for an improved method, system and apparatus for treating a liquid over the existing art. There is a need in the art for such a method, system and apparatus for treating a liquid that can be easily installed, economically manufactured and operated. And there is a very perceptible need for an improved method, system and apparatus for treating wastewater over the existing art.

### SUMMARY OF THE INVENTION

The present invention alleviates one or more of the drawbacks of the background art by addressing one or more of the existing needs in the art.

Accordingly, the present invention provides a method of treating liquid, especially, but not limited to, water, with electrocoagulation, using magnesium or other materials, in an agitated environment, in accordance with at least one embodiment of the invention.

The present invention provides a method and an apparatus for destabilizing colloidal solutions using turbulent fluid to overcome the energetic barrier of the colloidal solution, facilitate colloid agglomeration and facilitate solid-fluid separation, in accordance with at least one embodiment of the invention.

The present invention provides a method and an apparatus for treating industrial wastewater, food processing wastewater, and other types of fluids containing colloids, so as to reduce the concentration of ammonia nitrogen, ortho-phosphate, chemical oxidation demand (COD) and BODS, as well as FOGs, TSS, and heavy metals, using electrocoagulation in accordance with at least one embodiment of the invention.

The present invention provides a method and an apparatus for treating liquid with electrocoagulation that agglomerate colloidal solutions in accordance with at least one embodiment of the invention.

The present invention provides a method of treating liquid with electrocoagulation that uses anodes made of a magnesium-based alloy in the liquid in accordance with at least one embodiment of the invention.

The present invention provides a method and an apparatus for treating liquid with electrocoagulation that provides severe electrolytic conditions capable of attacking organic molecules responsible of soluble DCO, inter alia, phenols in accordance with at least one embodiment of the invention.

The present invention provides an apparatus for treating liquid with electrocoagulation provided with a modular electrocoagulation apparatus that can be easily installed and/or replaced in a process in accordance with at least one embodiment of the invention.

The present invention provides an apparatus for treating liquid with electrocoagulation that uses an electrocoagulation module including an anode module and a cathode module in accordance with at least one embodiment of the invention.

The present invention provides an apparatus for treating liquid with electrocoagulation provided with a modular anode that can be easily replaced, like a cartridge in accordance with at least one embodiment of the invention.

The present invention provides an apparatus for treating liquid with electrocoagulation that uses a movable anode adapted to add kinetic energy in the liquid to treat in accordance with at least one embodiment of the invention.

The present invention provides an apparatus for treating liquid with electrocoagulation that uses an anode module including of a plurality of anodic materials in accordance with at least one embodiment of the invention.

The present invention provides an apparatus for treating liquid with electrocoagulation that uses an anode module including of a plurality of anodes equally disposed thereabout in accordance with at least one embodiment of the invention.

The present invention provides an apparatus for treating liquid with electrocoagulation that uses an anode module including a plurality of anodes geometrically disposed thereabout in accordance with at least one embodiment of the invention.

The present invention provides a method of treating liquid with electrocoagulation that uses an anode module made of a plurality of replaceable anodes adapted to react and agglomerate different types of contaminants in accordance with at least one embodiment of the invention.

The present invention provides a method of treating liquid with electrocoagulation that uses an anode module including a plurality of anodes having various geometrical section like, but not limited to, semi-cylindrical, cylindrical, frustoconical, square, round, triangular, . . . to react in various fashion with cathode to agglomerate different types of contaminants, each anode being adapted to be consumable or inert, in accordance with at least one embodiment of the invention.

The present invention provides a method of electro destruction and weakening of refractory molecules responsible for soluble COD. Electro destruction is an oxidation process assisted with the action of electric current that weakens refractory molecules that are then easier to destroy. Generally, they are attacked by the action of oxidizing agents that can be added (adding hydrogen peroxide or percarbonate) or generated in situ by the action of electric current on acids such as sulphuric acid or simply water (production of free radicals and persulfates) in accordance with at least one embodiment of the invention.

The present invention provides a method of electro destruction and reduction of toxic molecules such as polychlorinated biphenyls (PCBs) and ethylene glycol, with or without chemical assistance in accordance with at least one embodiment of the invention.

The present invention provides an electrocoagulation module functioning on the principle of a sacrificial anode (Al, Fe, Mg, Ca, etc.), subjected to the application of a potential difference between the anode and a cathode. The cathode can either be made of steel or other metal identical to the anode depending of the fluid parameters and under the application of a potential difference that causes an agglomeration of particles in the fluid around the released ion. The particles formed thereof are evacuated with the flow of fluid in accordance with at least one embodiment of the invention.

The present invention provides a method of electro-synthesis and preparation of calco-magnesio hydroxyled and fluorided apatite Ca₁₀-xMgₓ(PO₄)₆F₂, Ca₁₀-xMgₓ(PO₄)₆OHOH₂. Apatites are a family of isomorphs compounds of fluorapatite: Ca₁₀(PO₄)₆F₂.

The present invention provides a method for electro-synthesis apatites using a synthetic chemical that is a reacted solution containing Mg²⁺ and Ca²⁺ with a solution containing the PO₄³⁻. The method is a synthesis in which the electrolysis process injects Mg²⁺ through the application of electric current in accordance with at least one embodiment of the invention.

The present invention provides a combination of electrocoagulation and mechanical agitation of the anodes for better performance. Agitation of the anode can be made in a circular fashion by rotating or reciprocating motion and can also be done inside or outside the electrocoagulation module in accordance with at least one embodiment of the invention.

The present invention provides a method for dephosphating industrial wastewater, municipal wastewater and food processing wastewater by formation of Mg₃(PO₄)₂ complex in accordance with at least one embodiment of the invention.

The present invention provides a method and an apparatus providing a pre-thickened industrial liquid sludge, municipal liquid sludge, and food processing liquid sludge with 1% initial dryness to more than 8% final dryness without adding polymer therein. Raw sludges have a dry content of 1-2% and should be pre-thickened with polymers before being dehydrated. The addition of polymers increases the amount of sludge and makes them viscous. A pre-thickening with electrocoagulation-electro flotation would decrease or eliminate the amount of polymer to be added in accordance with at least one embodiment of the invention.

The present invention provides a method and an apparatus for applying an electric current to procure bacterial reduction that can be achieve as follows: disintegration of cell wall (that causes osmotic lysis); membrane permeability modification; modification of intercellular constituents; nucleic acids alteration; protein synthesis interference; abnormal redox processes induction; and enzyme activity inhibition in accordance with at least one embodiment of the invention.

The present invention provides a kit comprising an anode module, a cathode module adapted to be operatively secured to the anode module, and a quick-loading anodes replacement cartridge in accordance with at least one embodiment of the invention.

The present invention provides a method of treating a colloidal fluid to remove contaminants contained therein, the method comprising injecting the colloidal fluid containing contaminants in an electrolytic system including an electrocoagulation module comprising an anode; and a cathode, the anode and the cathode being adapted to be electrically connected to perform electrolysis of the fluid; providing an electric current, between the anode and the cathode, to form electro-coagulated contaminants flocs in the fluid; and for the formed flocs to be separated from the fluid and ultimately extracted from the system.

The present invention provides a modular electrolysis system for treating fluid for removing colloid contaminants contained therein, the modular electrolysis system comprising an electrocoagulation module including an inlet and an outlet, the electrocoagulation module being adapted to include a removable and quick-loading anodes cartridge therein and a cylindrical cathode module for performing electrolysis of the fluid in the electrocoagulation module in accordance with at least one embodiment of the invention.

The present invention provides a quick-loading electrode cartridge suitable for replacing electrodes in an electrocoagulation reactor. More precisely, the present invention attempts to provide a solution for replacement of electrode cartridge in electrocoagulation systems and devices which have a specially designed quick-loading electrode cartridge.

An electrolysis kit for treating a fluid to remove colloid contaminants contained therein, the kit comprising an electrolytic module; an anode module adapted to be operatively inserted in the electrolytic module; and at least one anode adapted to be assembled to the anode module, the anode material being defined to produce one electrolytic process selected from electrocoagulation and/or electro-floatation.

The present invention also provides a quick-loading electrode replacement cartridge that may suitably be inserted into the body of the reactor and be replaced whenever sacrificial anodes, have been almost completely consumed. For instance, when the anodes are close to being used up (less than 10% of mass remaining) as indicated by a special feature programmed in the Programmable Logic Controller (PLC) and transmitted to the Human Machine Interface (HMI), thereby alerting the operator to replace the spent cartridge with a fresh one. This feature simplifies and speeds up this particular maintenance operation that must be performed periodically on most electrocoagulation reactor. This novel quick-load electrode cartridge allows substantial reduction in operational expenses and maintenance requirements associated with the electrocoagulation reactor, thus making it more competitive on the market and attractive to a broader client base.

The present invention, due to continuous monitoring of the remaining mass of the anodes displayed on the HMI, allows the operators to anticipate and plan the timing of the replacement of the quick-loading anodes cartridges. Such a feature also helps to alleviate the burden of the maintenance requirements.

The special design of the present quick-loading electrodes cartridge offers an ease of disassembly and assembly of the quick-loading electrodes cartridge. An important aspect of the present configuration is the proper alignment of the electrodes with respect to the cathode(s) Likewise, the present system and method require substantially water-tight, structural support and strength to ensure the smooth operation of the electrocoagulation reactor.

The quick-loading electrodes cartridges are generally pre-assembled electrodes designed to smoothly slide down within the reactor when inserted from the top of the reactor during the electrodes replacement operation. The quick-loading electrodes cartridge is preferably guided along the walls down to the bottom of the reactor. As such the quick-loading electrodes cartridge may generally be slid down into the reactor with ease and rapidity. The lowering of the quick-loading electrodes cartridge into the reactor is generally guided all the way down, preferably on guiding tracks. Once fully inserted, the lower guiding disk preferably locks the cartridge into position.

In order to replace the quick-loading electrodes cartridges, the operator is only required to unscrew the fasteners securing the cover plate located at the top of the reactor in order to remove the consumed cartridge. The operator then proceeds with the insertion of a new quick-loading electrodes cartridge into the reactor. The operator then replaces the cover plate on top of the quick-loading electrodes cartridge.

Other objects and further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

Additional and/or alternative advantages and salient features of the invention will become apparent from the following detailed description, which, taken in conjunction with the annexed drawings, disclose preferred embodiments of the invention.

### BRIEF DESCRIPTION OF THE DRAWINGS

The above and other aspects, features and advantages of the invention will become more readily apparent from the following description, reference being made to the accompanying drawings in which:

FIG. 1 is a schematic illustration of a modular electrolysis apparatus 10 in accordance with at least one embodiment of the invention;

FIG. 2 is a schematic illustration of a modular electrolysis apparatus in accordance with at least one embodiment of the invention;

FIG. 3 is a schematic illustration of a modular electrolysis apparatus in accordance with at least one embodiment of the invention;

FIG. 4 is a schematic illustration of a modular electrolysis apparatus in accordance with at least one embodiment of the invention;

FIG. 5 is a schematic illustration of a modular electrolysis apparatus in accordance with at least one embodiment of the invention;

FIG. 6 is an illustrative flow chart of an exemplary series of steps in accordance with at least one embodiment of the invention;

FIG. 7 is a schematic illustration of a modular electrolysis apparatus in accordance with at least one embodiment of the invention;

FIGS. 8 a), b) and c) is a schematic illustration of an anode module in accordance with at least one embodiment of the invention;

FIGS. 9 a), b) and c) is a schematic illustration of an anode module in accordance with at least one embodiment of the invention;

FIGS. 10A and 10B are schematic illustrations of possible anodes configurations on the anode module in accordance with embodiments of the invention;

FIG. 11 is an illustrative fluid flow illustration of an exemplary electrolysis system in accordance with at least one embodiment of the invention;

FIG. 12 is an illustrative illustration of an exemplary electrolysis system in accordance with at least one embodiment of the invention;

FIG. 13 is an illustrative fluid flow illustration of an exemplary electrolysis system in accordance with at least one embodiment of the invention;

FIG. 14 is an illustrative exemplary decanter module in accordance with at least one embodiment of the invention;

FIG. 15 is an illustrative exemplary decanter module in accordance with at least one embodiment of the invention;

FIG. 16 is an illustrative exemplary decanter module in accordance with at least one embodiment of the invention;

FIG. 17 is a lateral view of the exterior of an electrocoagulation reactor in accordance with at least one embodiment of the invention;

FIG. 18 is a perspective view of the exterior of an electrocoagulation reactor of FIG. 17;

FIG. 19 is a schematic view of the interior of an electrocoagulation reactor in accordance with at least one embodiment of the invention;

FIG. 20 is a lateral view of the quick-loading electrode cartridge in accordance with the principle of the present invention;

FIG. 21 is a perspective view of the electrodes of the quick-loading electrode cartridge of FIG. 20;

FIG. 22 is an exploded view of the quick-loading electrode cartridge of FIG. 20;

FIG. 23 is an exploded view of a quick-loading electrode cartridge having two layers of semi-cylindrical electrodes;

FIG. 24 is a perspective view of the electrodes of a quick-loading electrode cartridge of FIG. 20;

FIG. 25 is a perspective view of the electrodes of a quick-loading electrode cartridge of FIG. 23;

FIG. 26 is a schematic illustration of a modular skid of electrolysis reactors in accordance with at least one embodiment of the invention;

FIG. 27 is a cross-sectional view of the quick-loading electrode cartridge of FIG. 20;

FIG. 28 is a cross-sectional view of the quick-loading electrode cartridge of FIG. 23;

FIG. 29 is a top view of the quick-loading electrode cartridge of FIG. 23;

FIG. 30 is a perspective view of the upper portion of quick-loading electrode cartridge of FIG. 20;

FIG. 31 is a top view of the quick-loading electrode cartridge of FIG. 20; and

FIG. 32 is a perspective view of the upper portion of the quick-loading electrode cartridge of FIG. 23.

### DETAILED DESCRIPTION OF THE PREFERRED EMBODIMENT

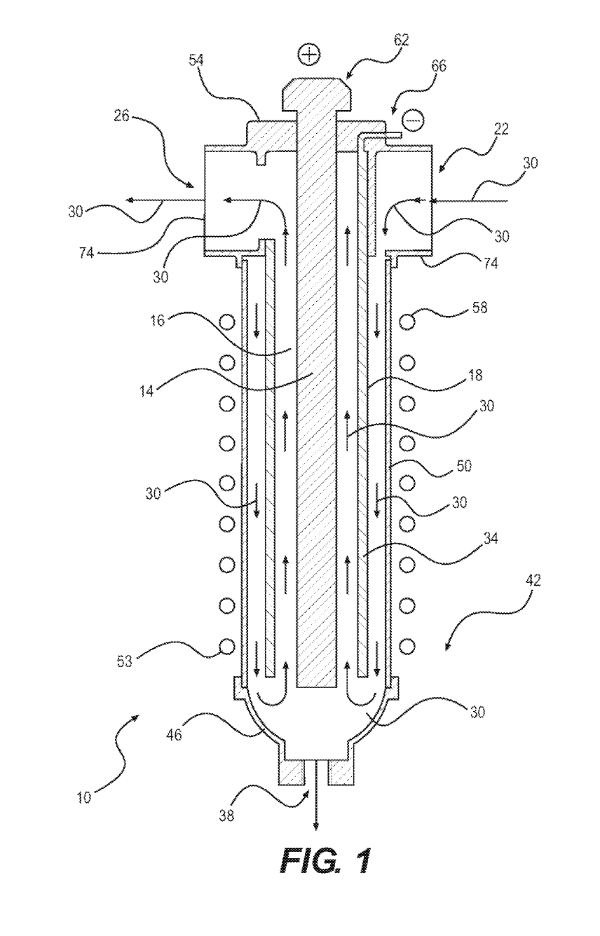

An exemplary electrocoagulation module 10 is illustrated in FIG. 1 with a section view allowing a better view of its construction. The electrocoagulation module 10 comprises an anode module 14 and a cathode module 18 adapted to interact in an electrolytic process producing electrocoagulation of undesirable colloidal particles. The electrocoagulation module 10 of the present embodiment includes an inlet 22 and an outlet 26 configured to respectively receive and extract the fluid to and from the electrocoagulation module 10. The fluid, once introduced in the electrocoagulation module 10, follows a path or a fluidic circuit configured to put the fluid in communication with the electrolytic process that is produced in the electrocoagulation module 10. In the present example, the fluid follows a path identified by a series of arrows 30 defined by internal walls 34. A pump, which is not illustrated in FIG. 1, pushes the fluid through the electrocoagulation module 10. An opening 38 disposed on a bottom portion 42 of the electrocoagulation module 10 is normally closed with a plug (not illustrated) to prevent the fluid to exit the electrocoagulation module 10. The opening 38 can be opened to remove the fluid from the electrocoagulation module 10 to purge the electrocoagulation module 10 for maintenance purposes, for instance. The electrocoagulation module 10 can also be purged to remove particles and debris. A larger closure member 46 is used to close the bottom portion of the electrocoagulation module 10 lower body 50. The closure member 46 can be optionally removed to provide a larger access in the electrocoagulation module 10. The lower body 50 can threadedly engage the upper body 54 and be removed from the upper body 54, if desirable.

Still referring to FIG. 1, the closure member 46 is located at the lower portion of the electrocoagulation module 10 to receive particles therein. The cathode module 18 is bottomless and allows the particles to drop in the closure member 46 acting as a particles-receiving member 46. The removable particles-receiving member 46 is preferably disposed in the center of the cathode module 18 as illustrated in the present embodiment and is used for removing decanted particles from the cathode module 18. The opening 38 in the closure member 46 can alternatively be used to inject gas, like air, or liquids for further conditioning the liquid in the electrocoagulation module 10 and/or influence the electrocoagulation process inside the cathode module 18.

The electrocoagulation module 10 further includes body portions 50, 54 that can optionally include insulating material to prevent heat transfer with the environment. Conversely, the electrocoagulation module 10 might be equipped with heating/cooling elements 58 to keep the electrocoagulation apparatus 10 at a predetermined operating temperature. The upper body 54 of an embodiment can be made of an insulating material preventing heat transfer between the inside of the electrocoagulation module 10 and the outside of the electrocoagulation module 10. The lower body 50 of the embodiment illustrated in FIG. 1 is made of a material that is less insulating the electrocoagulation module 10. Heating or cooling elements 58 are disposed, for example, in a spiral around the lower body 54 to either heat or cool the lower body 50. The heating or cooling elements 58 can use a fluid circulating in a tubular system or electric elements in contact with, or nearby, the lower body 50. Another embodiment is using the upper body 54 to transfer heat to/from the electrocoagulation module 10 in cooperation or not with the lower body 50.

Still referring to the embodiment of FIG. 1, the anode module 14 is secured to the upper body 54 and extends above the upper body 54 to allow electrical connection 62 thereto. The cathode module 18 of the present embodiment is also secured to the upper body 54 and extends therefrom 66 to allow electrical connection thereto. A power supply (not illustrated) is connected to the cathode module 18 to provide negative power thereof. Electrical polarity reversal is provided when desired to avoid passivation of the anode module 14 and the anodes 16 secured thereon. Insulators may be placed between two adjacent electrodes to prevent short circuits thereof. The cathode 18 and the anodes 16 are subjected to DC current. One skilled in the art can also appreciate that the upper body 54 is made of an insulating material to prevent establishing an electrical connection between the cathode 18 and the anode 14 modules.

The anode module 14 can be made of soluble or inert materials. The cathode module 18 can be made of steel, aluminum, stainless steel, galvanized steel, brass or other materials that can be of the same nature as the anode module 14 material or having an electrolytic potential close to the electrolytic potential of the anode 16. The cathode module 18 of the present embodiment has a hollowed cylindrical shape, fabricated of sheet material, and can be equipped with an optional lower frustoconical portion (not illustrated in FIG. 1). The inter electrode distance of an embodiment of the invention is about between 0.32-1 inch (8-25 mm) and preferably 0.4 inch (10 mm) for electro floatation and 0.8 inch (20 mm) for electrocoagulation. The interior of the cathode module 18 electrically interacts with the outside of the anode module 14. The electrocoagulation module 10 internal wall includes non-conductive material, like polymer, in an embodiment of the invention. The cathode module 18 could alternatively serve as a reservoir, or reactor, at the same time thus holding the liquid to treat therein in other embodiments. The cathode module 18 can be made of a material different from the anode material 16 or can alternatively be made of the same material, like, for instance, magnesium.

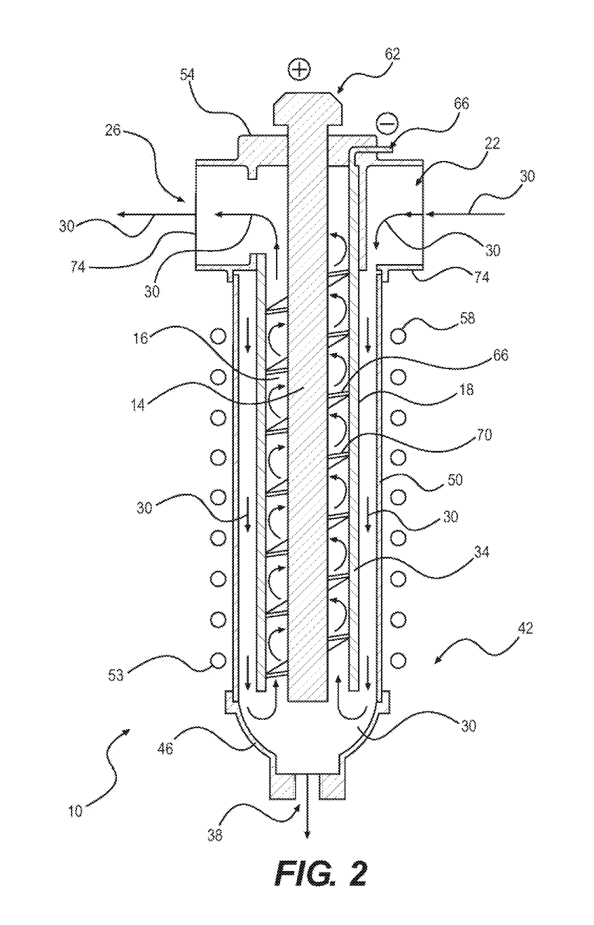

The size and the available active surface area of the cathode module 18 can be adapted to various conditions without departing from the scope of the present invention. The surface ratio of the cathode/anode can be identical or vary to about 1.5. The cathode module 18 of other embodiments can alternatively be oval or conical; its diameter expending upward or downward. The electrocoagulation module 10 can include therein an optional fluid agitator module 66 adapted to apply kinetic energy to the fluid contained in the electrocoagulation module 10 by moving or vibrating the fluid in the electrocoagulation module 10 as it is illustrated in the embodiment depicted in FIG. 2.

As mentioned above, the movement of the fluid increases the kinetic energy contained therein to destabilize the colloidal solution. This can be achieved by turbulently injecting the fluid in the electrolytic module (the speed and tangential injection of the fluid are possible ways to create turbulences in the fluid). The electrocoagulation module 10 embodied in FIG. 2 is substantially similar to the electrocoagulation module 10 embodied in FIG. 1 with the difference that the electrocoagulation module 10 in FIG. 1 is equipped with a fluid agitator module 66. The fluid agitator module 66 in this embodiment is a spiral shaped protrusion member 70 that is secured to the anode module 14. The movement of the fluid between the anode module 14 and the cathode module 18 is intensified by the protrusion member 70, which influences the electrolytic process. The anode module 14 of an alternate embodiment that is not illustrated in FIG. 1 and FIG. 2 could be rotatably secured to the upper body 54 of the electrocoagulation module 10 and be rotated by an external motor to rotate the anode and the protrusion members secured thereon to apply additional kinetic energy to the fluid as it will be discussed below. As it is illustrated in FIG. 1 and FIG. 2, the anode module 14 is preferably centered inside the electrocoagulation module 10 and preferably located at equal distance from the cathode module 18.

The electrocoagulation module 10 of FIG. 1 and FIG. 2 further comprises a pair of electrocoagulation module connectors 74 adapted to operatively install the electrocoagulation module 10 in a larger fluid treatment process, as it will be discussed in mode details below. The electrocoagulation module 10 can removably be mounted in series, or in parallel, in the fluid treatment process. This way, the electrocoagulation module 10 can easily be added, maintained, replaced and/or removed from the fluid treatment process.

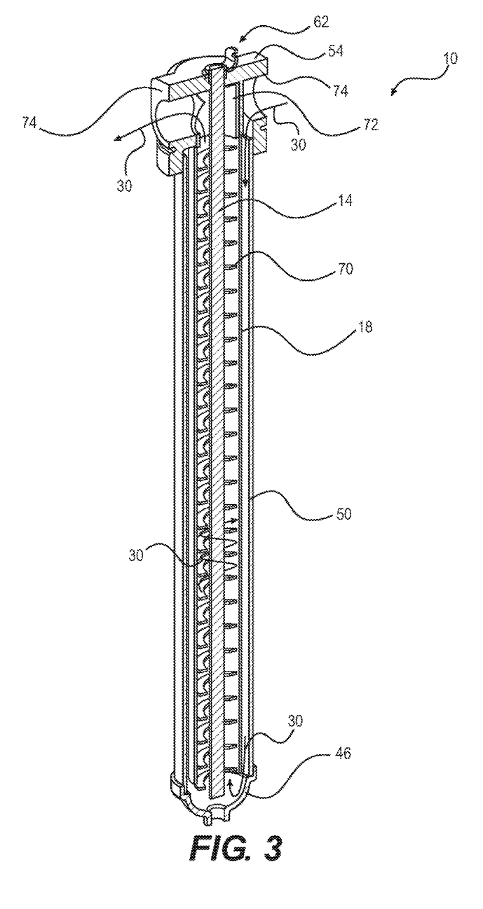

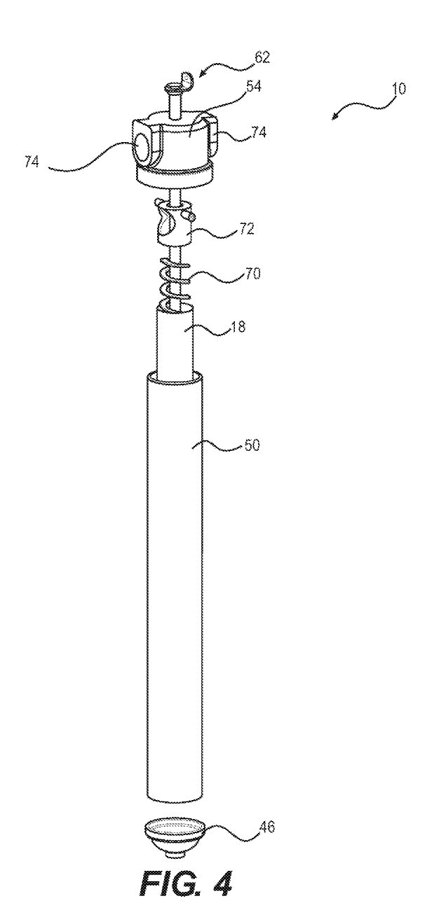

FIG. 3 and FIG. 4 illustrate additional views of the electrocoagulation module 10 equipped with a spiral protrusion member 70. One can appreciate from FIG. 3 and FIG. 4 that a fluid distributor 72 can be installed inside the electrocoagulation module 10 to channel the entering fluid downward between the cathode module 18 and the lower body 50 to make the fluid raise back between the anode module 14 and the cathode module 18 before it exits the electrocoagulation module 10 through the opening defined therein. One can appreciate from FIG. 3 that the spiral protrusion member 70 is substantially perpendicular to the anode module 14 and is used to add kinetic energy to the fluid passing along by adding turbulences. In an embodiment of the invention, the fluid is pushed in the electrocoagulation module 10 and the sole movement of the fluid in respect with the static spiral protrusion member 70 increases the energy in the fluid that augment the number of shocks that can lead to a more rapid agglomeration of particles therein.

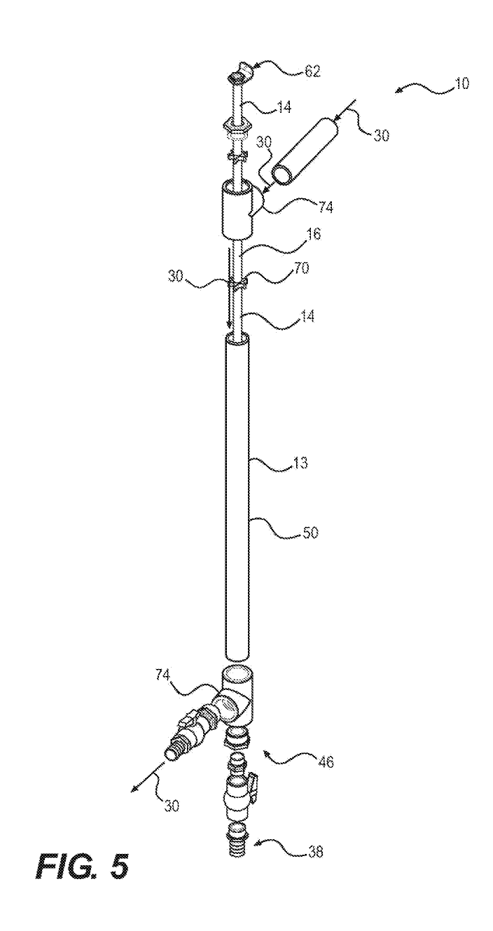

Moving now to FIG. 5 illustrating another embodiment of a simplified electrocoagulation module 10 having a rod-type anode module 14 disposed in an hollowed cathode module 18 also used as a lower body 50 in which flows the fluid to be treated. Small protrusion members 70 are disposed on the anode module 14 to agitate the fluid passing nearby in the electrocoagulation module 10 according to the fluid path identified by arrows 30.

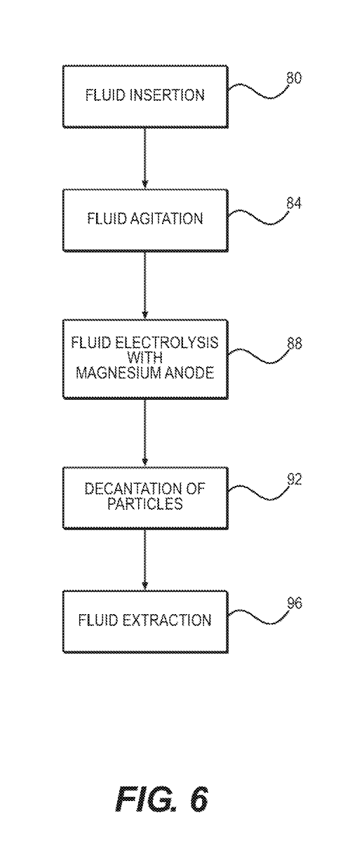

As best seen in FIG. 6, a typical series of steps are illustrated for using electrocoagulation to flocculate particles in accordance with an embodiment of the invention. Firstly there is insertion of a fluid 80 in the electrocoagulation module 10 and agitation of the fluid 84 with the anodes 16 movements increases the electrocoagulation speed. The fluid electrolysis 88 with an exemplary magnesium anode 16 begins. It has to be noted that a magnesium anode is used in the present illustrative embodiment although other anodic materials could be used as explained above. The fluid is subjected to an electric current and electrolysis is made between the cathode module 18 and the anodes 16 to increase the size of the particles contained in the fluid. The particles are then decanted 92 and/or filtered and the treated fluid is extracted from the electrocoagulation module 10.

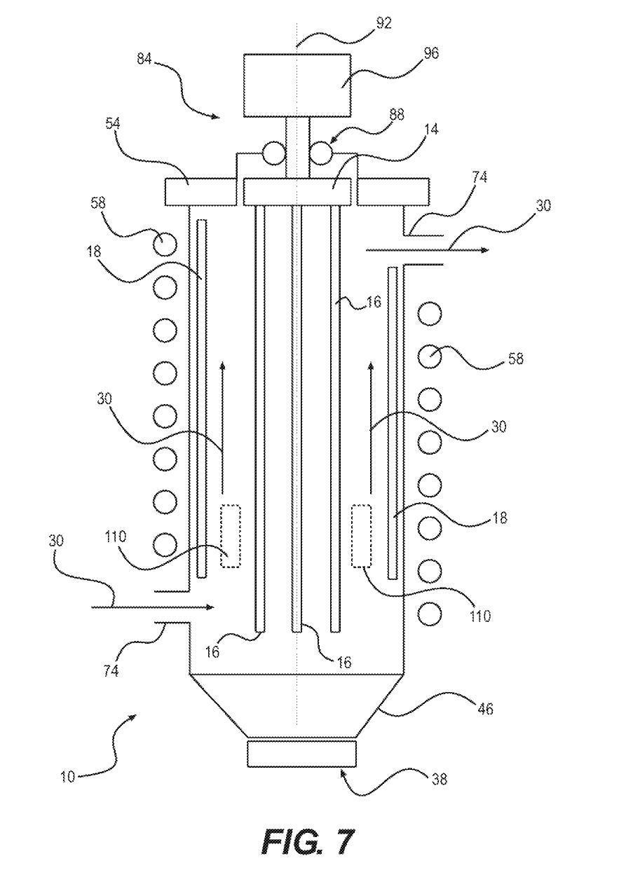

Referring to FIG. 7, the electrocoagulation module 14 might contains an optional fluid agitator module 110 to further agitate the fluid in the cathode module 14 and thus increase the kinetic energy of the fluid. The fluid agitator module 110 can be mechanical and adapted to mechanically agitate the fluid. The fluid agitator module 110 can alternatively be electrically actuated with a specific frequency in a form of ultra sounds.

The upper body 54 of the electrocoagulation module 10 embodied in FIG. 7 includes an anode module-receiving portion 84 adapted to receive therein a rotatable anode module 14. The anode module receiving portion 84 of the illustrated embodiment is provided with a bearing member 88 adapted to allow a rotation or a pivotal motion of the anode module 14 inside the electrocoagulation module 10 about an anode module vertical axis 92 and in respect with the cathode module 18 to add kinetic energy to the fluid in the electrocoagulation module 10. A motor 96, operatively connected to the anode module 18, provides the rotation and/or the pivotal of the anode module 18. As it can be appreciated, the anode module receiving-portion 84 is provided with seals (e.g. “O”-rings, not illustrated) and a fastening mechanism (not illustrated) to properly seal and secure the anode module 14 in the electrocoagulation module 10.

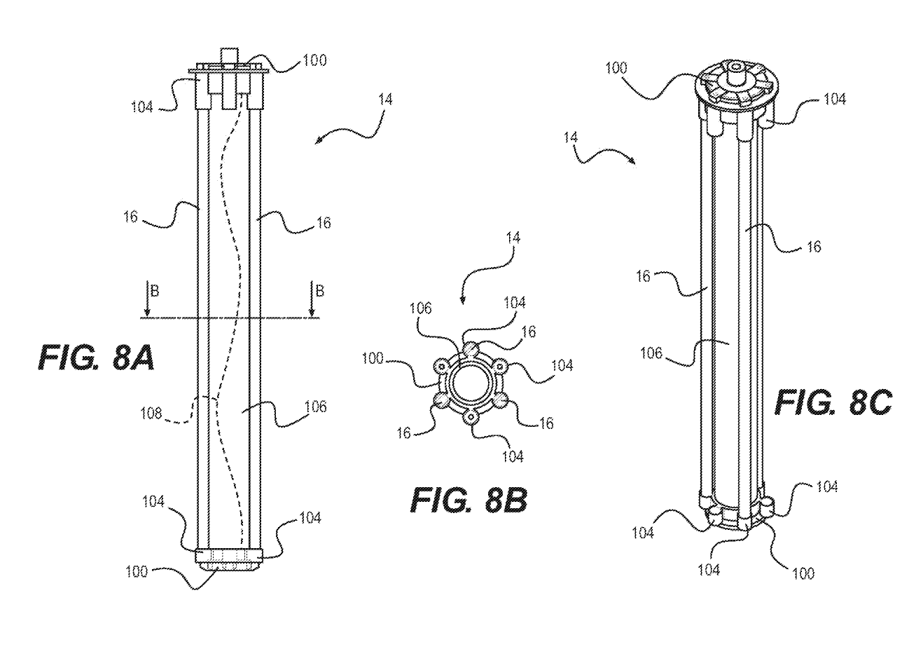

The cathode module 18 can include one or many anodes 16, as it can be appreciated in the embodiment of FIG. 8, which can be individually or collectively be made of Mg, Al, Fe, Ca, or any other suitable material. The anode module 14 is operatively connected to an anode module 24. It can be appreciated by a skilled reader that consumable and inert (non-consumable) anodes 16 can be collectively used to simultaneously produce electrocoagulation and electroflotation. Also, it can be appreciated that a continuous flow of fluid is desirable for a continuous treatment of the fluid in the electrocoagulation module 10. The turbulent flow conditions of the fluid in the reactor have for effect to increase the number of particle collisions in the fluid and thus the kinetic energy contained in the fluid.

An anode module 14 can accommodate a plurality of anodes 16 as embodied in FIGS. 8 a) through 8 c). The anodes 16 can be made of different materials depending of the type of contaminants contained in the fluid to clean because different anodic materials will interact differently with different contaminants and provide further advantages. The distance between the anodes 16 and the cathode module 18 can also be adjusted using polarity reversal if desirable.

FIGS. 8 a) through 8 c) referred above illustrate a general anode module 14 embodiment where two opposed anodes holders 100 provided with a plurality of anode-receiving portions 104 adapted to receive therein an anode's extremity. The two opposed anodes holders 100 are held together by a junction member 106 to form a unitary structure. The junction member 106, to retain the anodes 16 in their respective and opposed anodes holders 100, provides a longitudinal tension. The opposed anodes holders 100 can be disassembled from the junction member to insert the anodes 16 in their respective opposed anode-receiving portions 104. Plastic or other non-conductive materials can be used to manufacture the junction member 106 to prevent electric current to be conducted by the junction member 106 between the anodes holders 100. The non-conductive junction member 106 is unlikely to interfere in the electrolysis process that is occurring only with the anodes 16 in relation with the cathode module 18. An optional conductor, like an electrically conductive wire 108, can be integrated into the junction member 106 to electrically connect the two opposed anodes holders 100 to ensure proper current distribution within the anodes 16 in an embodiment of the invention.

Alternatively, the opposed anodes holders 100 could be made of a non-conductive material in another embodiment. In the later embodiment the conductive wire 108, or any other electrically conductive element would electrically connect the anodes 16. A conductive junction member 106 can be used in embodiments using non-conductive anodes holders 100. The conductive junction member 106 could be used as another cathode providing an electrolytic surface to the anodes 16 on the opposite side of the cathode module 18 to perform a more even electrolysis of the anodes 16.

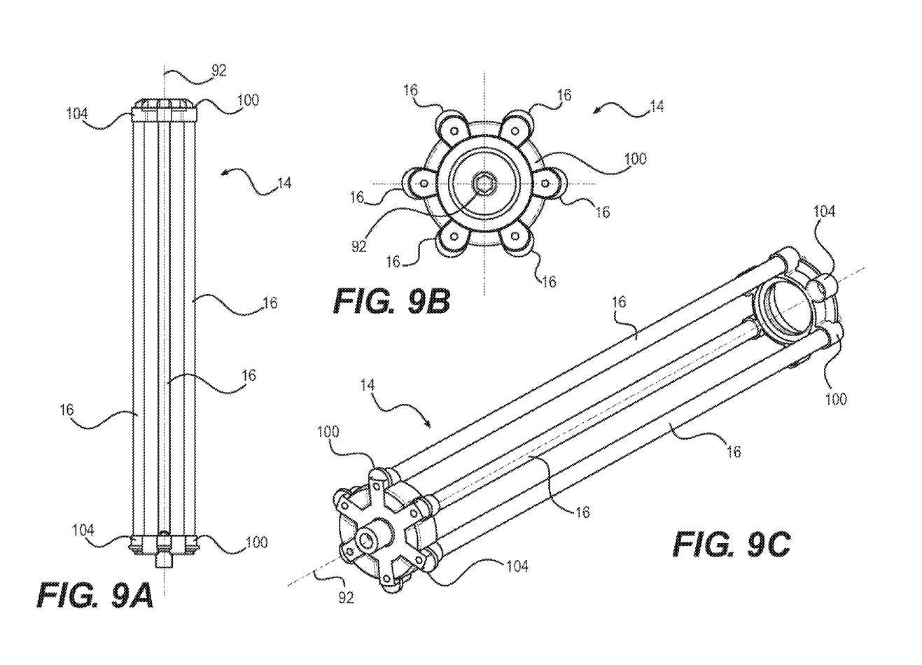

The anode module 14 having a plurality of anodes 16 thereof can be embodied like the anode module 14 illustrated in FIGS. 9 a), b) and c). The anode module 14 includes two opposed conductive anodes holders 100 adapted to secure therebetween six anodes 16 (a different number of anodes 16 can be used if desirable). The anode module assembly thus created may be used to rotate, or angularly reciprocate, in the electrocoagulation module 10 to add kinetic energy to the fluid in the electrocoagulation module 10. The anodes holders 100 are sized and designed to easily replace anodes 16 thereon. The anodes holders 100 are also adapted to receive anodes of different shapes, materials and are furthermore adapted to leave some anode-receiving portions 104 empty, as it will be discussed in greater details below.

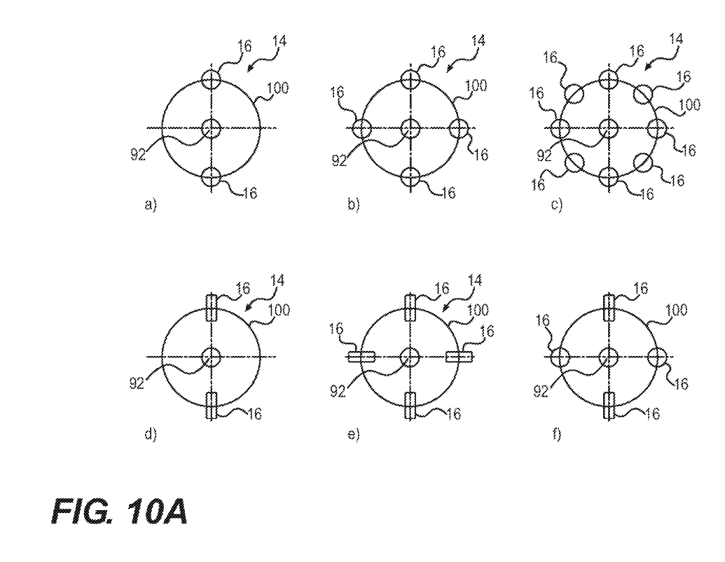

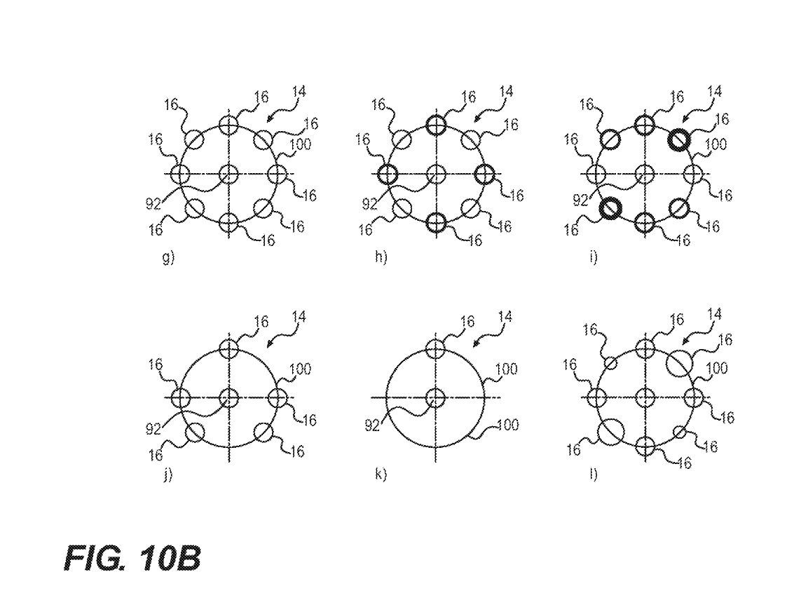

FIG. 10 a) through FIG. 10 I) illustrates a plurality of anode modules 14 with different configurations of anodes 16 thereon. There are many possible variations and some are illustrated with different number of anodes 16, anode sizes (e.g. small, medium, large, thin, thick) and with different shapes. These different anodes holders 100 configurations are presented for illustrative purpose and do not intend to limit the possibilities to the illustrated anode module 14 configurations.

The particularity of the anode module 14 of the illustrated embodiment is that it is designed like a multi-headed anode module 14 with anodes 16 thereon. A different number of anodes 16 and the position of the anodes 16 on the anode module 14 illustrated herein can vary to adjust to the fluid to be treated without departing from the scope of the present invention. The position of the anodes 16 in respect with the cathode module 18 is optionally ensured by insulating supports (not illustrated) in order to avoid uneven wear of the anodes 16. The cathode module's 18 surface area may be larger than the combined surface areas of the anodes 16 to improve electrolytic performance. The cathode 18 surface area might be equal or smaller than the surface area of the anodes 16 by making a reduction of the cathodes' 18 surface area. The design of the cathode module 18 and the anodes 16 included in the anode module 14 depends, inter alia, of the amount of contaminants contained in the fluid and the flow of fluid to be electrocoagulated.

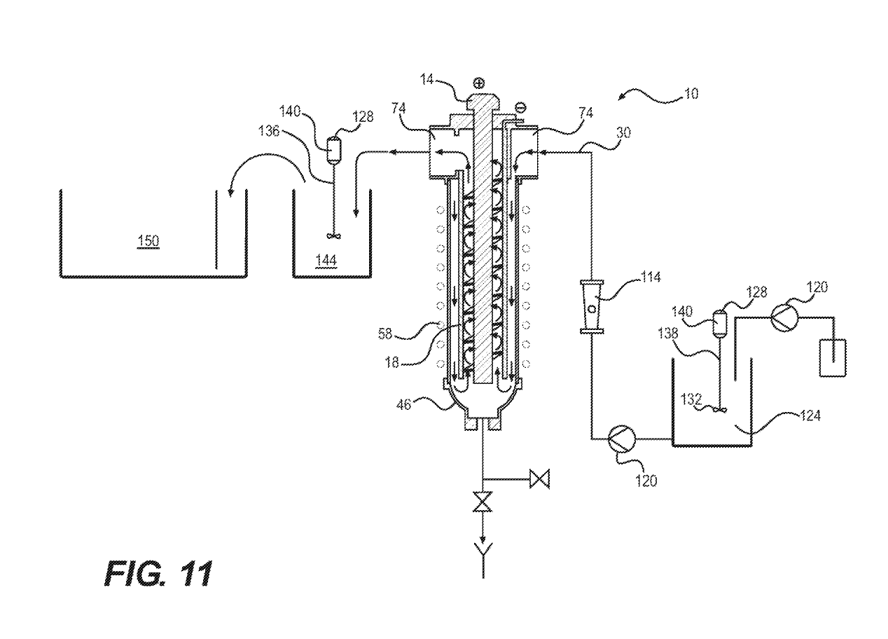

The cathode module 14, or the body 30, includes at least two electrocoagulation module connectors 74 serving as fluid inlets and outlets. The electrocoagulation module connectors 74 can be associated with optional filters 114 adapted to filter particles of filterable sizes as it is illustrated in FIG. 11. The electrocoagulation module 10 connectors 74 can be disposed anywhere on the electrocoagulation module 10. Preferably, the electrocoagulation module connectors 74 are disposed on opposite sides to help prevent direct fluid communication thereof.

The aforementioned electrocoagulation module 10 herein refers to uses consumable electrodes to electrocoagulate colloidal solutions. The same electrocoagulation module 10 can accommodate non-consumable electrodes, passive electrodes (i.e. non-conductive electrode), therein to be transformed into an electroflotation module 12. The electroflotation module 12 produces microbubbles in the fluid therein that helps lifting the particles in the fluid. The electrocoagulation module 10 and the electroflotation module 12 can be used separately or in combination in a process. Moreover, electrocoagulation and electroflotation can be obtained in a single reactor by combining consumable and inert anodes 16. The present description used above a single electrocoagulation module 10 for explanation purposes. The text below refers to a process using either a single electrocoagulation module 10 as illustrated in FIG. 11, a single electroflotation module 12, a combination of a plurality of electrocoagulation modules 10, a combination of a plurality of electroflotation modules 12 and a combination of electrocoagulation module(s) 10 and electroflotation module(s) 14. Alternatively a plurality of electrocoagulation modules 10 can be connected in series or parallel depending on the type of liquid and its impurities to be treated. The multiplication of electrocoagulation modules 10 can significantly increase the performance, speed and quality of the treatment. Each module 10, 12 can be associated with a conditioning module 144 and/or a decantation module 150.

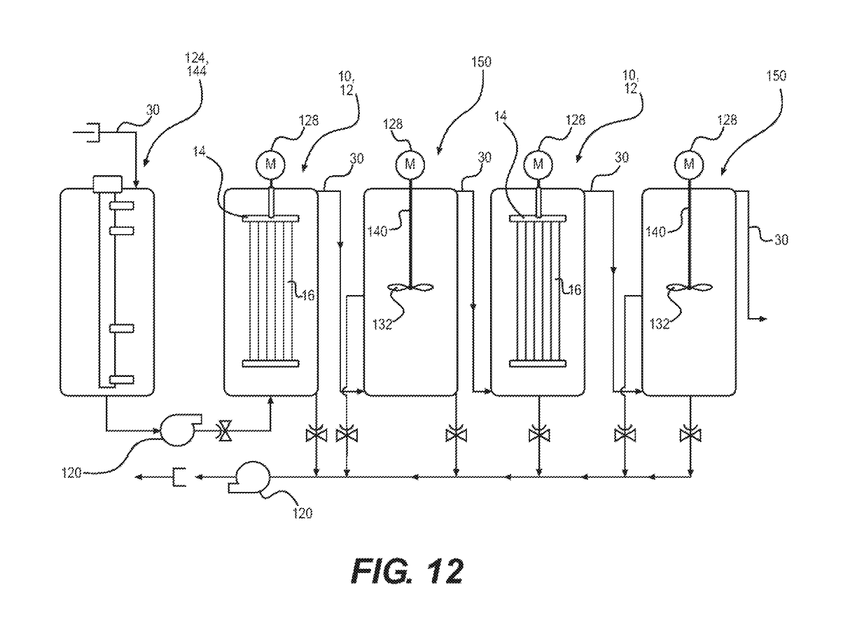

Turning now to FIG. 12 depicting some possible embodiments using an electrocoagulation module 10 in accordance with the present invention directed, inter alia, to the removal of organic particles and inorganic particles, like phosphor. The fluid is pumped 120 into an agitated conditioning reservoir 124 provided with an agitator 128 to remove air from solid particles in a form of micro-bubbles (or to remove gas molecules from solid particles) and then passes through a primary filter 114 prior to be injected into the electrocoagulation module 10. The agitated conditioning reservoir 124 is further equipped with an agitator 128 using blades 132 secured to an end of a rotating shaft 136 rotated by a motor 140. After the fluid is pumped with an optionally adjustable flow pump 114 in the electrocoagulation module 10. The fluid is “energized” by the protrusion members 70 secured to the anode module 14 disposed in the electrocoagulation module 10 as explained in details earlier. Once the fluid has passed through the electrocoagulation module 10 it goes to a conditioning module 144 also provided with an optional agitator 128 using blades 132 secured to an end of a rotating shaft 136 rotated by a motor 140. The conditioning module 144 is used to condition the fluid prior to entering a process phase by homogenising, changing the pH, changing the chemistry of the fluid to improve the reactiveness of the fluid flowing through the electrocoagulation module 10 and/or the electro-flotation module 12. Its volume can illustratively be of about 500-1000 liters per hour and can be provided with a means for homogenize the fluid, a conductivity regulator module (not illustrated) and/or a pH regulator module (not illustrated). The fluid treated thereof is then ready to be used. A fluid analysis module (not illustrated) is alternatively provided at a position along the fluid path in the treatment system to determine the chemical oxygen demand contaminants level contained in the fluid, at that position, treated by the electrolysis system, the fluid analysis module being adapted to include one of an infra-red detector and a turbidity probe.

FIG. 12 illustrate an embodiment directed to the removal of COD particles, suspended solid matter and soluble organic matter. The principle is quite similar to the embodiment illustrated in FIG. 11 with some differences. Namely, there is a plurality of electrocoagulation modules 10 and homogenisation modules 144 operatively disposed in series. The fluid passes through a primary filter (not illustrated) and then reaches a conditioning reservoir 124 and conditioning module 144 prior to be injected into a first electrocoagulation module 10. The fluid is electrocoagulated a first time in the first electrocoagulation module 10 and is released into a first decantation module 150 further equipped with an agitator 140 equipped with blades 132 secured to an end of a rotating shaft 136 rotated by a motor 128. The fluid is optionally precisely pumped with an adjustable flow pump (not illustrated) disposed along the process. A second electrocoagulation module 10 is followed by a second decantation module 150 to remove COD residual particles. The fluid is mixed with rotatable anodes 16 disposed in the electrocoagulation module 10 as explained in details earlier.

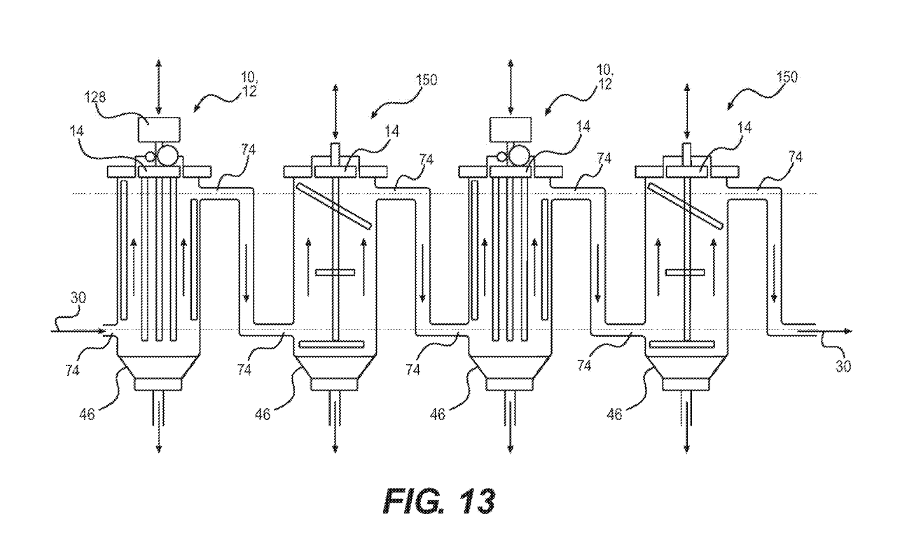

The fluid can be transferred from an electrocoagulation module 10, or an electroflotation module 12, to a decantation module 150 in at least another embodiment as it is illustrated in FIG. 13. The decantation module 150 is preferably equipped with internal routings adapted to help separate particles from the fluid that will be discussed in details below.

FIG. 13 illustrates a series of electrocoagulation modules 10, and/or electroflotation modules 12, and decantation modules 150. One can appreciate that the connectors 74 are vertically at the same height to ensure efficient fluid transfer between the modules 10, 12, 150. It can also be appreciated that the anode module 14 is vertically adjustable to set the length of the anodes 16 in the fluid and adjacent to a corresponding cathode module 18. The same vertical adjustment principle is used in the decantation modules 150 to set the height of the internal routings for proper fluid routing. Once the fluid has passed through an electrocoagulation module 10 it goes to a decanter module 150 to further separate remaining particles. The fluid treated thereof is then extracted from the system.

Finally, FIG. 13 can illustrate an embodiment directed to pre-thickening. The principle still resembles to the embodiment illustrated in FIG. 12 with at least the difference that there is no electro-flotation module 14 and no conditioning modules 144. The last stage of the process with this embodiment consists in removing fluid on a dripping table to separate the particles contained therein, which is not illustrated in FIG. 13.

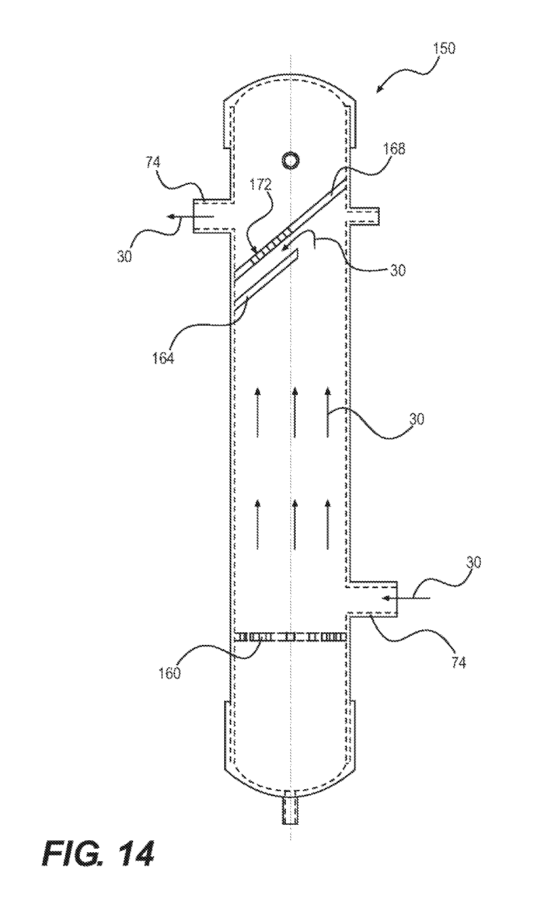

FIG. 14 through FIG. 16 depicts three different embodiments of decanter modules 150. The decanter module 150 is generally used to help separate particles from the fluid. It achieves that by slowing down the fluid, preferably in a laminar flow, to let gravity attract heavier particles to the bottom of the module 150 to be later drained out. More precisely, in respect with FIG. 13, the fluid enters the connector 74 above a punctured separator 160 adapted to let the particles fall through to the bottom of the decanter 150 and also prevent the inbound fluid to carry the particles at the bottom of the decanter 150 aspirated by the flow. The fluid then move up slowly given the larger diameter of the decanter module 150 to pass between two separating plates 164, 168, forming a channel at about 35 degree angle. Separating plate 168 includes a series of holes 172 sized and designed to let the fluid pass through to reach the exit connector 74 without creating turbulence in the fluid lower in the decanter module 150.

A cylindrical centrifugal decanter (not illustrated) of an embodiment of the invention can rotate at about 300 RPM. Such a centrifugal decanter could be provided with internal radial fins secured to a rotatable vertical motor-driven shaft to apply desirable movement to the fluid in the decanter.

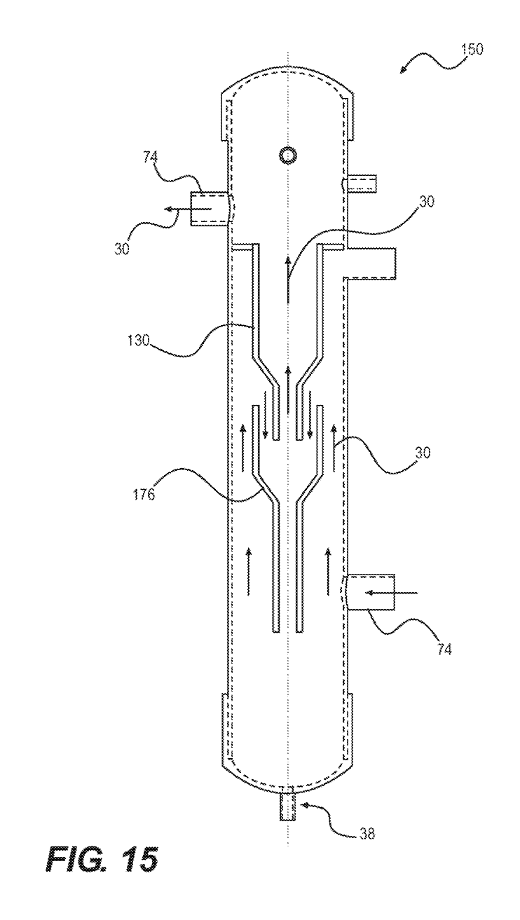

The embodiment illustrated in FIG. 15 uses a different internal structure to help separate the particles from the fluid. The fluid enters the decanter module 150 and as to move upward 30 to get downward into a first funnel-like separator 176 to change direction again upward to enter a second funnel-like separator 180 to finally reach the exit connector 74 above. One can appreciate from that design that the first separator 176 has a hole in its center connected to a tubular portion 184 extending down lower than the entering connector 74 to prevent the entering fluid to bypass the first separator 176 and to allow particles to fall through the first separator 176 to the bottom of the decanter module 150.

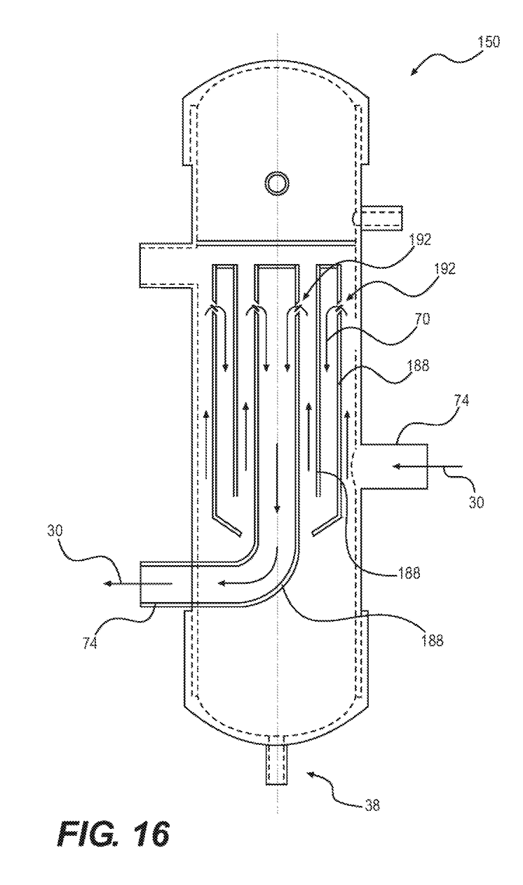

A third decanter 150 embodiment is illustrated in FIG. 16. This embodiment also slows down the flow of fluid to allow heavier particles to fall down in the decanter 150. A number of channels 188 are defined inside the decanter 150, with holes 192 at specific locations, to direct the fluid. It can be appreciated that the entering connector 74 faces a channel's wall and forces the fluid to move upwardly thus allowing the heavier particles to fall at the bottom of the decanter 150. The fluid passes through the holes 192 to get to the second layer of channels 188 to finally move downward to reach exit connector 74. It can also be appreciated that openings 192 are defined in the lower portion of the channels 188 to let particles fall to the bottom of the decanter 150 to later be drained.

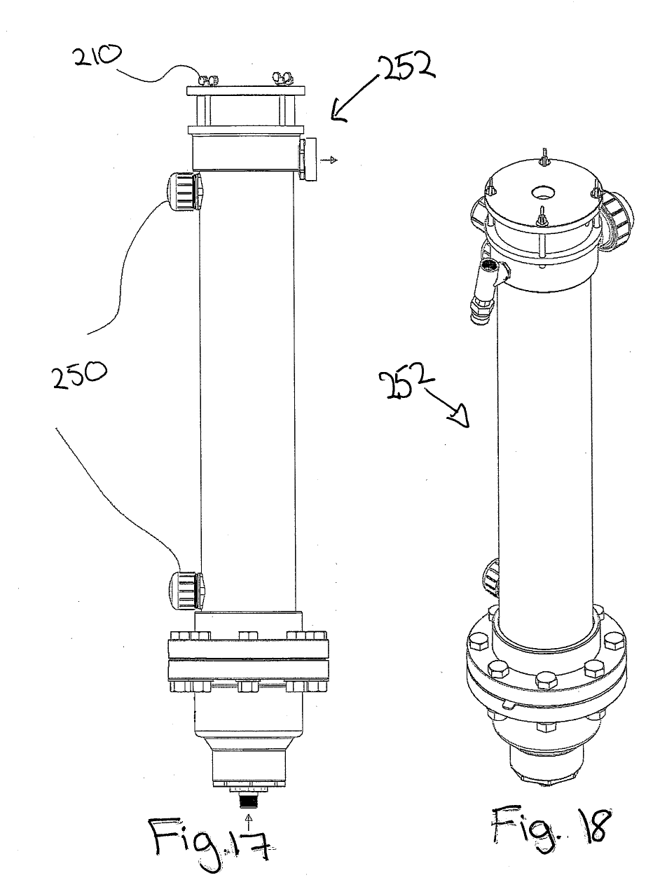

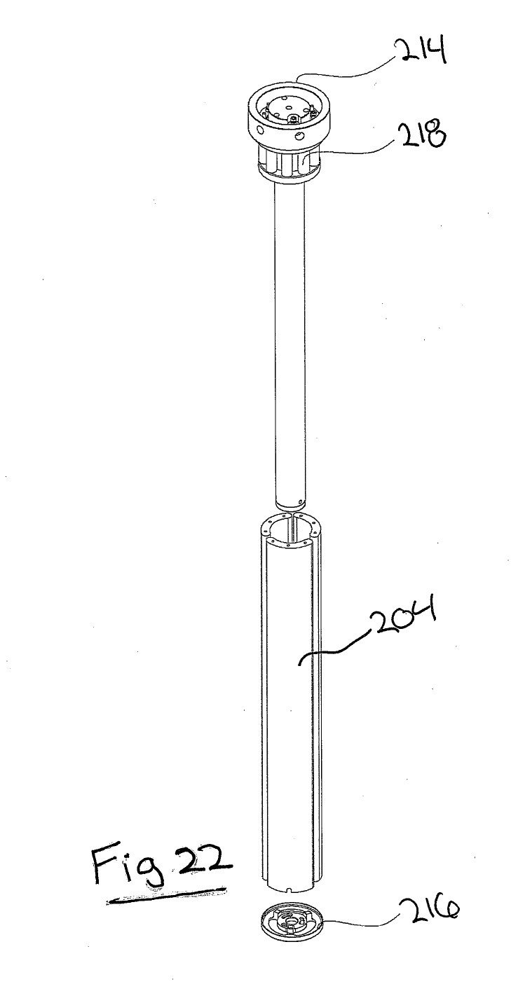

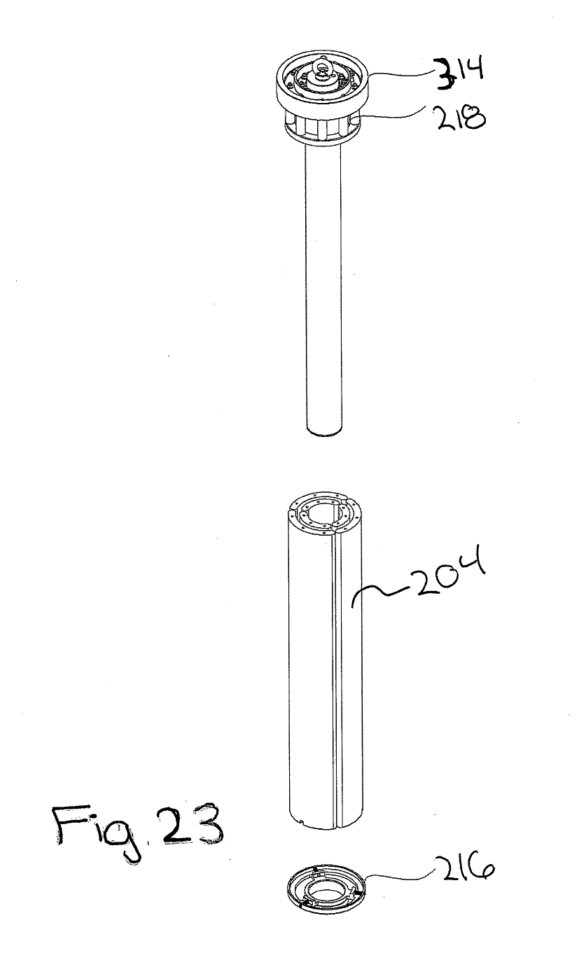

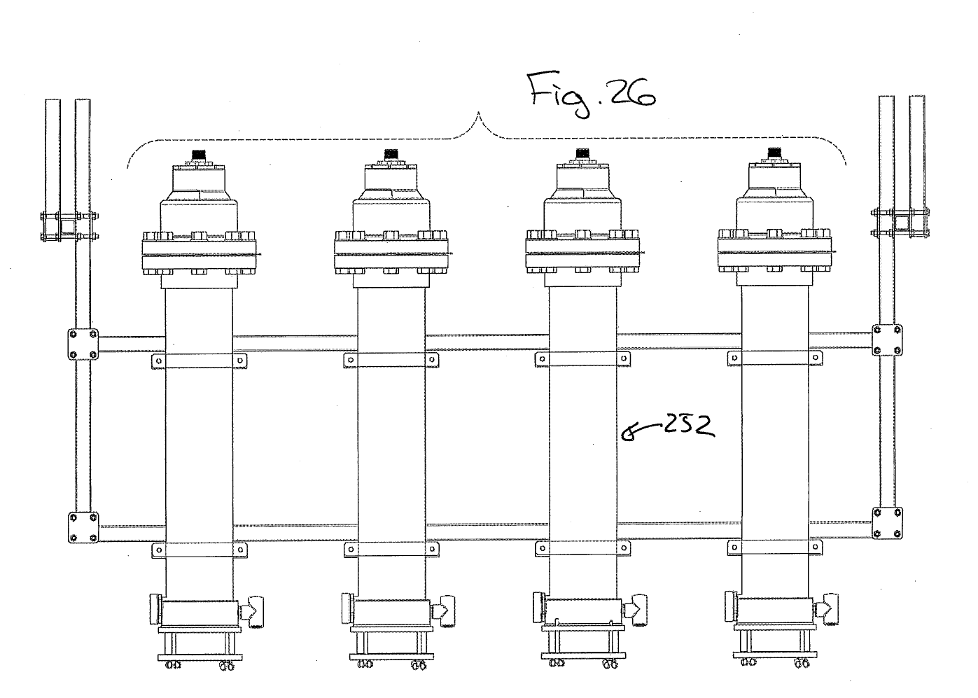

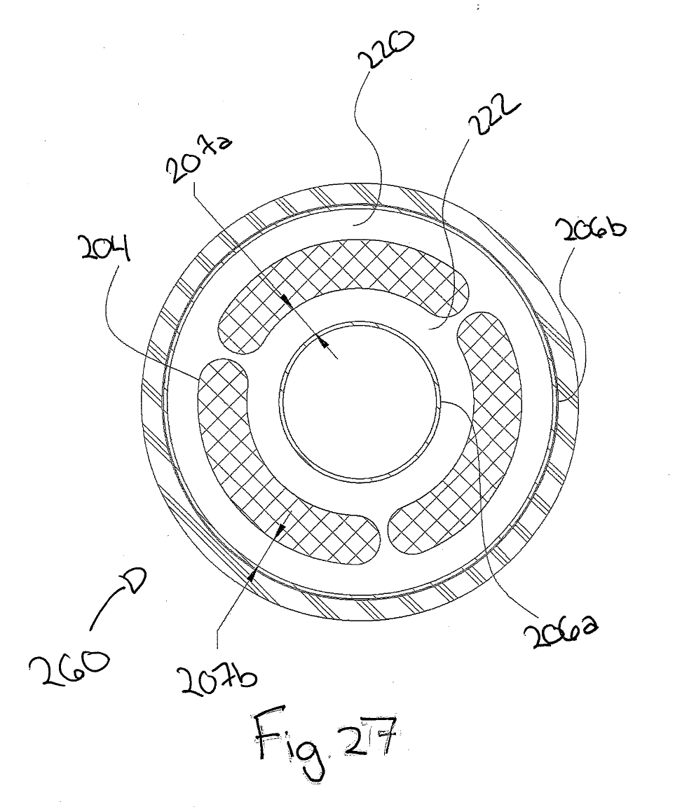

According to other embodiments, now referring to FIGS. 17-32, novel electrode cartridge systems for electrocoagulation modules in accordance with the principles of the present invention are shown. FIGS. 22-23 show how semi-cylindrical electrodes 204, such as anodes, may be assembled to the structural components 214, 218, 206, 216 of the quick-loading electrode cartridge 260 for an electrocoagulation system.

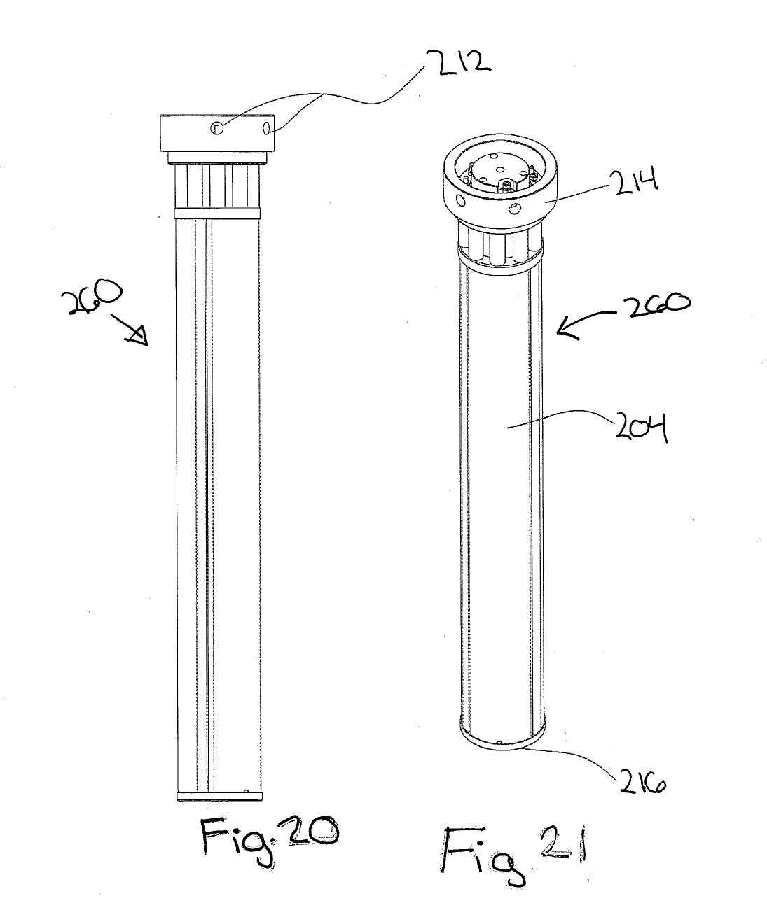

According to another embodiment, now referring to FIGS. 20 and 21, an electrode cartridge system for an electrocoagulation system in accordance with the principle of the present invention is shown.

Now referring to FIG. 17, the electrocoagulation module 252 comprises a novel semi-cylindrical electrodes 204 installed therein. In the embodiment shown in FIGS. 17 to 32, the electrodes of the quick-loading electrode cartridge 260 (FIGS. 20-22) comprise both anodes 204 and cathodes 206. Another embodiment could use the principle of the present invention with a quick-loading electrode cartridge 260 wherein the electrodes of the quick-loading electrode cartridge 260 are cathodes, anodes or any suitable combination thereof.

According to an embodiment to the present invention, the electrolysis reactor typically comprises two locations for high temperature switches 250. The two high temperature switches 250, one at the top and one at the bottom of the reactor 252, are generally used to prevent overheating of the electrolysis reactors 252 in no-flow or in low-flow conditions. Also part of the interior of an electrolysis reactor is a flow dispersion chamber 202. The flow dispersion chamber 202 is generally located above the inlet port at the bottom of the reactor 252.

The novel quick-loading electrode cartridge may be designed for a variety of electrocoagulation module such as the single layer semi-cylindrical anode 204 electrocoagulation module (SAEM) or the double layer semi-cylindrical anode 204a, 204b electrocoagulation module (DAEM). Both the SAEM and the DAEM comprise anode 204 and cathodes 206 arranges in a substantially concentric manner.

In the SAEM embodiment, now referring to FIG. 27, the quick-loading electrode cartridge 260 generally comprises three semi-cylindrical anodes 204 positioned between an inner cylindrical cathode 206a and an outer cylindrical cathode 206b. Both cathodes 206a, 206b, are substantially cylindrical in shape and are generally configured to match the inner and outer shape of the SAEM. Such a concentric arrangement allow the system to function at optimal efficiency.

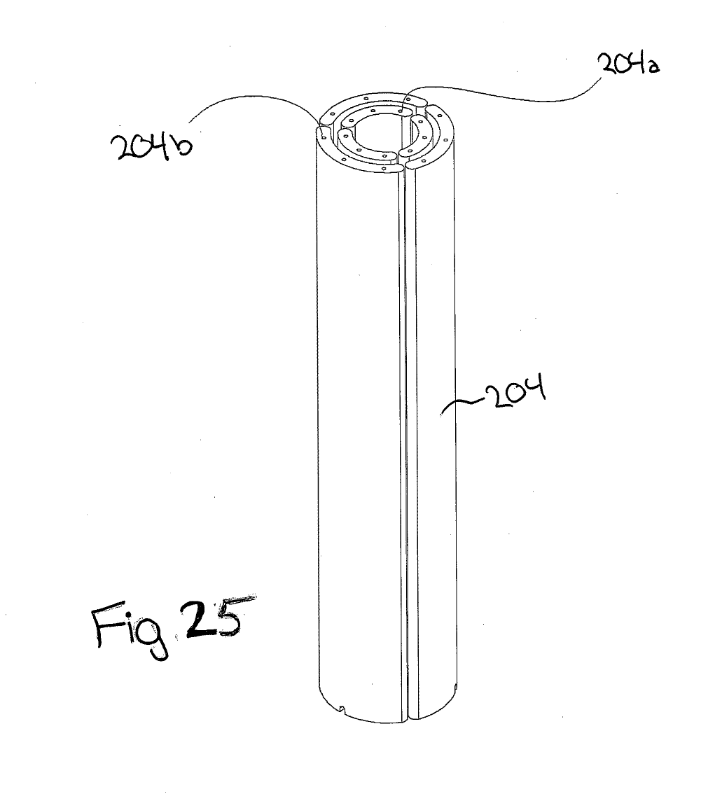

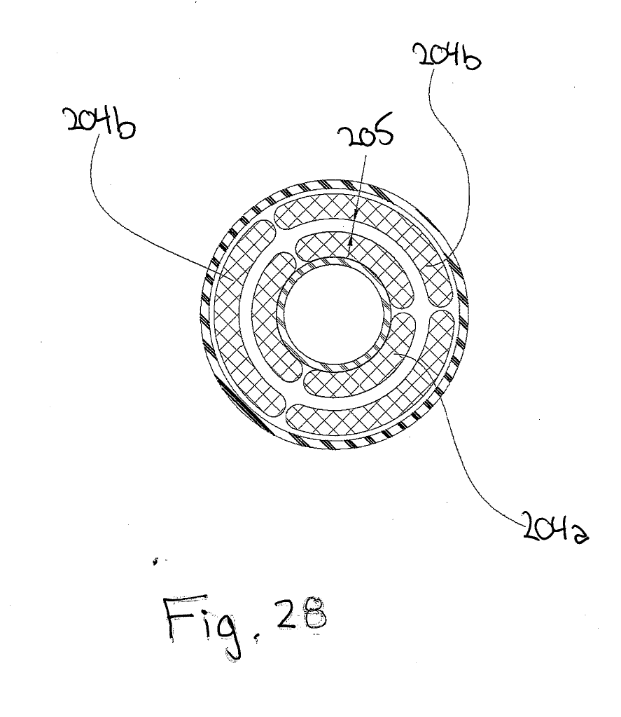

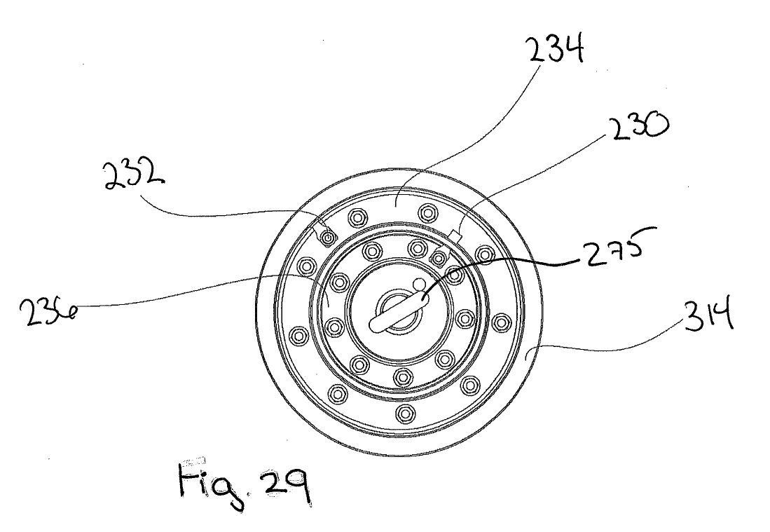

In the DAEM embodiment, now referring to FIGS. 25 and 28, the quick-loading electrode cartridge 260 generally comprises at least two semi-circular inner electrodes 204a and at least two outer semi-circular electrodes 204b. In the preferred embodiment, the loading electrode cartridge 260 comprises three inner semi-circular anodes 204a, and three outer semi-circular anodes 204b, for a total of six (6) semi-cylindrical anodes. The DAEM is typically larger than the SAEM, as such, the DAEM is preferably configured to handle larger flow rate. For instance, where the SAEM may have a 6 inches (152 mm) diameter, the DAEM may have a larger 8 inches (203 mm) diameter.

In both the SAEM and the DAEM embodiments, now referring to FIGS. 22 and 23 respectively, the electrodes are secured to a crown member 214, 314 and a lower disk 216. The electrodes are typically secured to the crown member 214, 314 by a set of fasteners 265 to both ensure electrical conductivity and sound structural support. The details of how the semi-cylindrical electrodes may be assembled into the quick-loading cartridge are shown in FIG. 22 (SAEM) and in FIG. 23 (DAEM).

An important aspect of the present invention is the ability of both the SAEM and DAEM embodiment to use the polarity reversal feature of the systems. However, the DAEM has a configuration that is particularly suitable for such a use. For instance, in using the polarity reversal, each set of three semi-cylindrical anodes 204a, 204b would alternatively function as a cathode while the other sets of electrode act as anodes. The polarity reversal is generally favored in order to control the consumption of anodes. As such, the consumption of the anodes 204, which is generally the sacrificial electrode, may be optimized over time, and distributed more evenly between the two sets of electrodes 204, 206. In addition, the recirculation of the fluid allow a uniform consumption of the anodes 204.

In this particular configuration of the electrodes, the anodes may reversibly be transformed into cathodes. Although this operation could be manually actuated, it is preferably automatically controlled by a PLC and a set of electrical switches located in the control panel of the system.

As such, a controlled reversal of polarity may generally be applied to compensate for the consumption of the anodes over time in order to maintain a relatively stable surface ratio between the anodes and the cathode(s). The preferred surface ratio for the present embodiment would generally approximate 1. As such, the operator will use the device in order to favor the consumption of the anodes 204 to obtain a surface ratio between the electrodes of approximately 1.

Likewise, the cathode may function as an anode for a determined amount of time, and then be reversed to acting as a cathode again, as the anode/cathode surface ratio has been re-established.

Now referring to FIGS. 27 and 28, the gaps or spacing 205, 207a, 207b, between the anodes and the cathode(s) allows the fluid to circulate as it flows in a generally upwards direction in the reactors 252. The fluid, in the present invention, acts as a conducting medium between the negative and the positive electrodes 204, 206, thus allowing the electrolysis treatment of the fluid to take place. As such, the gaps 207 between the anodes 204 and cathode(s) 206 create a reactive area 220, 222. Consequently, the configuration of the reactor 252 is designed in order to force the fluid to flow in the reactive area 220, 222, gaps between the cathode(s) and anodes inside the reactor.

A summation of all the gap areas 205, 207 or reactive areas 220, 222 yields the cross-sectional area of passage that is used to determine the flow rate required to establish a transition or turbulent flow regime inside the reactor. The gaps for the SAEM embodiment are shown in FIG. 27 and the ones for the DAEM embodiment are shown in FIG. 28. For example, the width of the gap 205, 207 for the SAEM embodiment could approximate 0.48 inch (12 mm) while the width of the gaps for the DAEM embodiment could approximate 0.4 inch (10 mm).

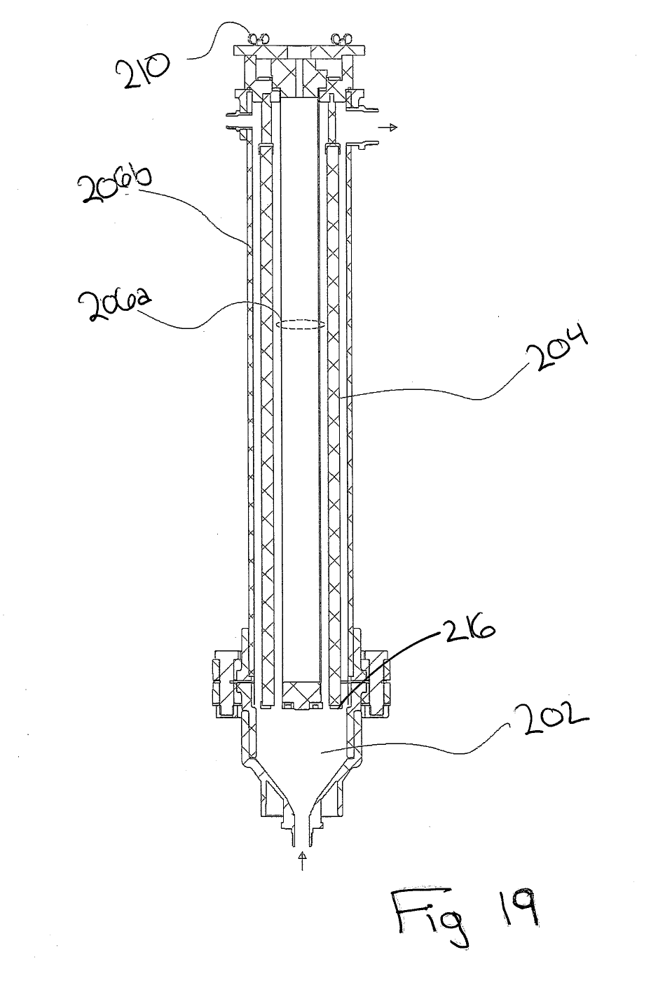

Now referring to FIGS. 19 and 22, an advantage of the present quick-loading electrode cartridge 260 is the ability to yields a reactive area approaching 100% over the entire length of the anodes 204. Therefore, the specific concentric arrangement and geometry of the anodes 204 and cathode(s) 206 substantially affects the efficiency of the reactive area 220, 222. Furthermore, the specific geometry of the electrodes 204, 206 allows the anodes 204 to be consumed in a substantially uniform manner. In other words, because of the geometry of the anodes 204, the presence of dead zones within the reactor section containing the quick-loading anodes cartridge 260 have been substantially diminished as opposed to prior art systems since the fluid necessarily has to pass between the anodes 204 and cathode(s) 206. In the preferred embodiment, there should exist no dead zone (zone wherein the fluid may flow without being subjected to the electrolytic reaction).

Similarly, insuring that the gap 205, 207 or spacing between the anodes 204 and cathode(s) 206 is kept as small as possible allows the electrocoagulation treatment to be performed using fluids of relatively low conductivity compared to other electrocoagulation reactors available on the market. Furthermore, the configuration and shape of the electrodes 204, 206 enables a relatively lower electrical consumption for the electrocoagulation process as it maximises the achievable conductivity within the reactor 252. Indeed, the smaller the gap 205, 207 or spacing between the anodes 204 and the cathode(s) 206, the smaller the distance that needs to be travelled across the fluid by the electrons to migrate from an anode to a cathode, thus the smaller the resistance for the electrocoagulation process.

Now referring to FIGS. 22, 24 and 27, the SAEM embodiment comprises a quick-loading anodes cartridge 260 that encompasses the parts generally associated to the section of a concentric arrangement fitted inside of an outer cathode 206.

Now referring to FIGS. 23, 25 and 28, the DAEM embodiment generally features a slightly different design from the design of the SAEM embodiment. In the DAEM embodiment, the entire concentric arrangement comes out as a quick-loading electrode cartridge 260 generally containing six semi-cylindrical electrodes 204a, 204b. As such, the specific concentric arrangement of the DAEM embodiment may be easily removed and inserted back. The quick-loading electrode cartridge 260 may generally be locked in place at the top of the reactor using suitable fasteners 210 such as butterfly bolts 210 which allow easy removal during maintenance while insuring proper securing of the quick-loading electrode cartridge 260 during operation of the reactors 252.

Still referring to FIGS. 27 and 28, in both the SAEM and the DAEM embodiments, some minor adjustments in the gap 205, 207 between the anodes 204 and the cathode(s) 206 may generally be achieved using a controlled polarity reversal sequence. Although the physical spacing between the anodes 204 and the cathode(s) 206 should preferably always be the same as initially, i.e. when the quick-loading electrode cartridge 260 is new, the consumption of the anodes 204 will affect the size of the gap 205, 207. This consumption generally widens the initial gap 205, 207 over time. Moreover, the anode 204 is generally being consumed over time while the volume of the cathode 206 is being maintained over the same period, thereby requiring minor gap adjustments.

In both the SAEM and the DAEM embodiments the cathodes 206 and the anodes 204 are fitted properly to ensure a water-tight design, which is critical for the wiring section that connects these electrodes to the DC power supply. The ‘pure’ cathodes 206 are cylindrical in shape and they are located at the inner and outer layers of the concentric arrangement of the SAEM embodiment.

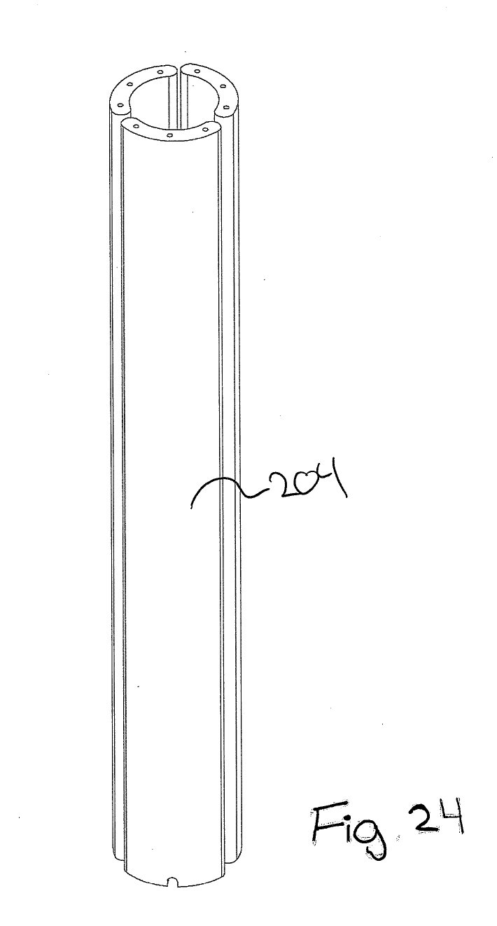

Now referring to FIG. 24, the semi-cylindrical anodes 204 of the SAEM embodiment have been designed based on a 5 inches diameter cylinder fractioned into three equal semi-cylindrical sections.

In the DAEM embodiment, now referring to FIGS. 23 and 25 a total of six (6) semi-cylindrical anodes 204 split into two sets of three (3) semi-cylindrical anodes 204 are used. For this particular arrangement, as mentioned above, one set of anodes 204 at a time may actually may act as cathode 206 with the aid of polarity reversal. On the one hand, the anodes 204a of the inner layer have been designed based on a 5 inches (123 mm) diameter cylinder generally fractioned into three equal semi-cylindrical sections, just like for the semi-cylindrical anodes of the SAEM embodiment. On the other hand, the anodes 204b of the outer layer have been designed based on a 7 inches (178 mm) diameter cylinder also generally fractioned in three equal semi-cylindrical parts, which fit inside an 8 inches diameter reactor such as the DAEM embodiment. Moreover, in the DAEM embodiment three (3) semi-cylindrical anodes 204 may generally be grouped together to form a cylinder (FIGS. 24 and 25). Such a grouping of electrodes 204, 206 may be done with any of the sets of semi-cylindrical anodes 204. In other words, each semi-cylindrical anode 204 represents a third of a cylinder, which has a length equivalent to the height span of the reactor dedicated to the electrocoagulation reaction. For example, both the SAEM and the DAEM embodiments could have a height of about 35 inches (900 mm).

The surface ratio between anodes 204 and cathodes 206 can be optimized to obtain the best possible treatment efficiency. As such, the operator should operate the present system in a way that will attempt to have a surface ratio of 1. Understandably, in the DAEM, the surface of the inner electrode is smaller than the surface of the outer electrode. In this kind of situation, the operator should preferably use the outer electrode until a surface ratio of approximately 1 is obtained. Then, the polarity reversal may be used to interchange the polarity of the electrode as to maintain a surface ratio of approximately 1. The geometry of both the SAEM and the DAEM embodiments was selected amongst other possible geometries because it has the ability to be housed within the volume of a cylindrical shape reactor 252 in accordance with the principle of the present invention.

In addition, the semi-cylindrical shape of the electrode 204, 206 was found to be cheaper to ship in large shipments as compared with similar shipment of cylindrical electrodes. As such, a large quantity of semi-cylindrical electrodes 204, 206 would result in a more efficient shipment in a sea freight cargo due to the relatively larger quantity of electrodes 204, 206 that may be contained in an equivalent volume since the volume of air trapped at the center of the cylindrical anode is substantially diminished. Contrary to cylindrical electrodes, semi-cylindrical electrodes 204 can be easily stacked on top of one another, thus minimizing the volume required for transportation and consequently optimising transportation cost. Another advantage of the semi-cylindrical geometry is that it facilitates handling (for example, the semi-cylindrical electrodes may weigh 3 to 5 kg a piece) by the operator since an individual weight of 3 or 5 kg is much easier to handle and to work with compared to an overall weight of 9 kg in the case of the quick-loading anodes cartridge for SAEM embodiment or 24 kg in the case of the quick-loading anodes cartridge for DAEM embodiment. This improvement in the shape of the electrode enhances the efficiency in the transportation of the electrodes. As such, the system could be provided to the users with additional cartridges. Upon consumption of the electrode, the user could simply remove the cartridge and replace is with the additional one. Subsequently, the user would replace the electrodes from the removed cartridge. As a result, the consumed electrodes would be replaced by new electrode while keeping the other component of the cartridge. Alternatively, the user could send the removed cartridge to a local provider which would replace the electrode from the cartridge. This allows a quick replacement of the cartridge and a very small down time of the system. The system thus only requires the replacement of the electrodes. Consequently, because the only portion of the cartridge which requires replenishment is the electrode, the transportation efficiency of this electrode is a very important factor in the efficiency of the system.

It is also shown how the lower guiding disk 216 is fitted at the bottom of the quick-loading anodes cartridge 260, which is generally designed to substantially fit onto the base portion of the reactor. The base portion of the reactor where the quick-loading anodes cartridge 260 generally sits is preferably located above the flow dispersion chamber.

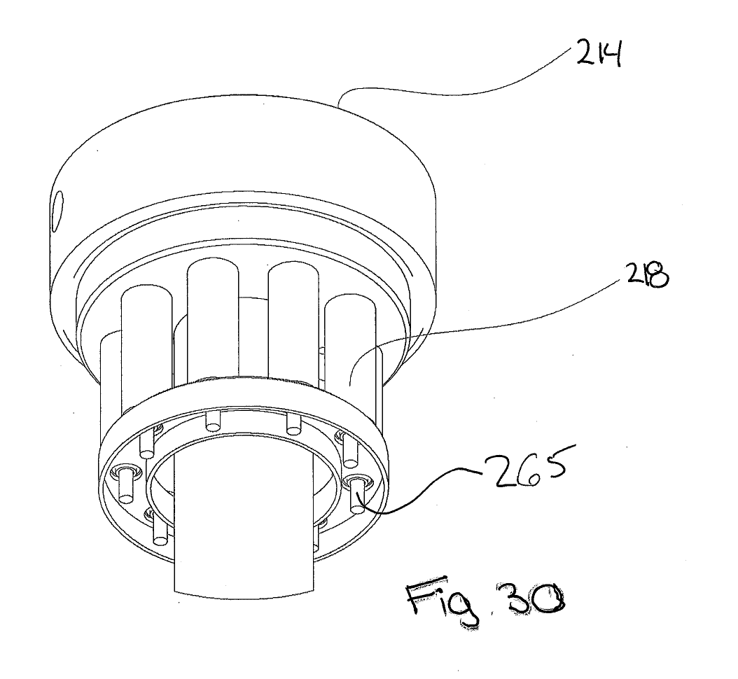

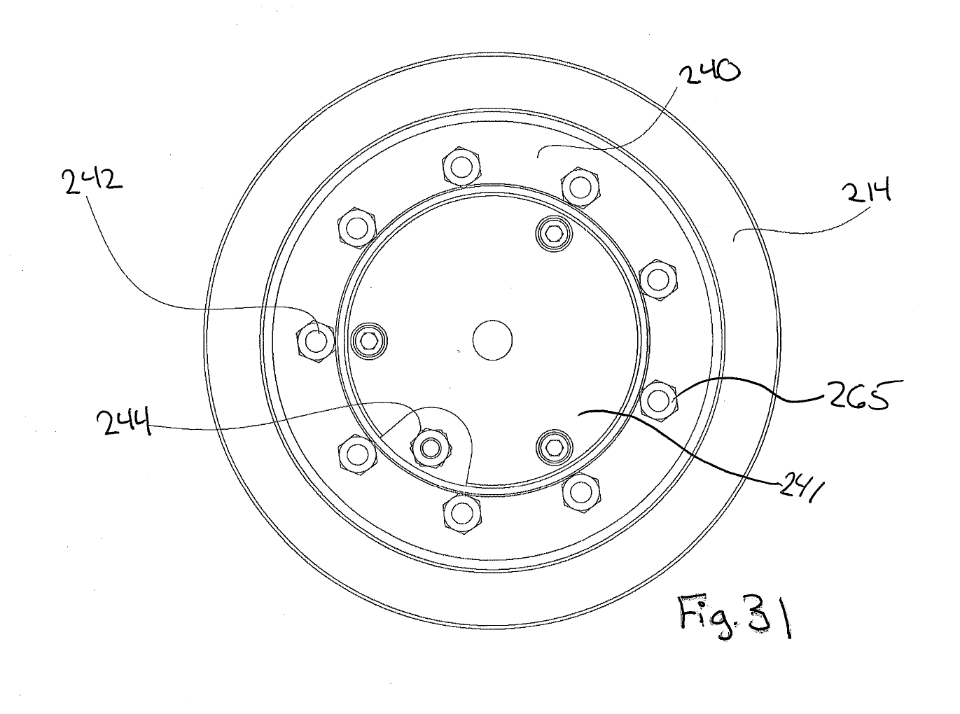

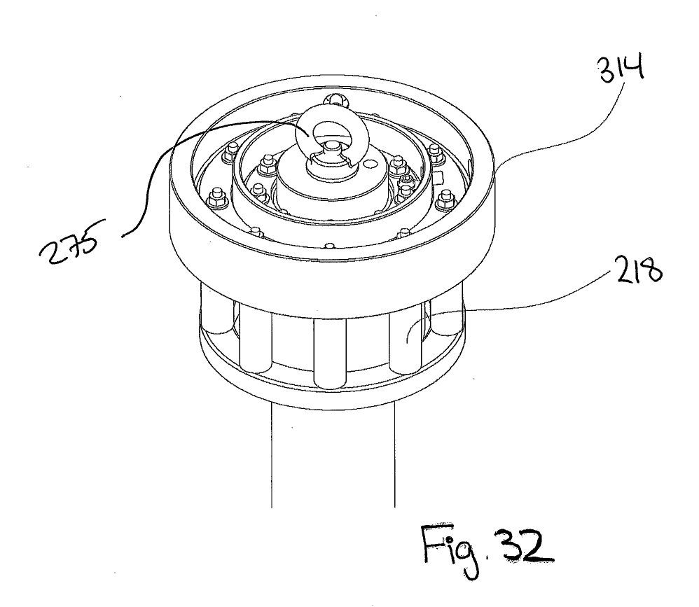

Now referring to FIGS. 29-32, in the SAEM embodiment, the three semi-cylindrical anodes 204 are generally secured to the crown portion 214 using fasteners 265. For instance, the quick-loading electrode cartridge 260 may be secured with a total of nine metal screws 265, three metal screws 265 per anode 204. A part of the metal screw 265 length is generally covered with a Ultra-High Molecular Weight Polyethylene (UHMW) material spacer 218 in order to isolate the screw 265 from the fluid contained in the reactor thereby preventing any short-circuit or unwanted electrical discharge (FIG. 30). Still referring to FIGS. 29-32, the crown portion 214 may have a hole positioned at the middle of the center thereof which may be used to insert a lifting attachment member 275, such as a ring, in order to support the hoist handling (FIG. 31). The lifting attachment member is typically used to lift the quick-loading electrode cartridge 260 from the electrocoagulation device according to the DAEM embodiment shown in FIGS. 29 and 23.

Still referring to FIGS. 29 and 32, the lifting attachment member 275 generally allow the lifting of the quick-loading electrode cartridge. As such, by lifting the crown portion 314 and the electrode 204a, 204b attached thereto, using the lifting attachment member 275, the operator may easily replace the cartridge 260 without any significant difficulties.

Furthermore, using the lifting attachment member 275 typically allows the cartridge 260 to be handled by a hook chained to a hoist, which can be used when the overall weight of the cartridge 260 exceeds a comfortable lifting weight for the operator or as per Occupational Health Safety & Environment (OHS&E) Procedures.

Electrical connections from the DC power supply to the electrical distribution rings (one for the cathode(s) 241 and one for the anodes 240) are made at the top of the crown 214, through a pair of circular holes 212 that are drilled into the water-tight crown 214 (FIG. 21). FIGS. 27 and 28 show how the superior part of the crown 214 is designed to hold the electrical distribution ring(s) 240, 241, and how the metal screws 265 are used to hold the anodes 204 firmly into position as well as being firmly connected to an electrical distribution ring 240, 241. The electrical distribution ring(s) 240, 241 are typically made of copper for great conductivity properties, and there is a separate connector for the cathode 244 and for the anodes 242. By doing so, DC current may be transported from the DC power supply, to the quick-connect DC power cables, to the electrical distribution ring(s) 240, 241, to the metal screws 265, and ultimately to the anodes 204 and cathode(s) 206. Because the DAEM uses two sets of semi-cylindrical anodes 204a, 204b, while SAEM uses two pairs of ‘pure’ cathodes 206a. 206b and a set of semi-cylindrical anodes 204, the design of the electrical distribution rings 234, 236 made at the top of the crown 314 are somewhat different, as seen in FIGS. 29 and 32. The inner distribution ring 236 generally comprises an inner electrode connector 230. The outer distribution ring 234 generally also comprises an outer electrode connector 232.

Securing the quick-connect DC power cables, i.e. one red cable and one black cable, officially completes the anodes replacement operation, which can easily be done within 2 min for the SAEM embodiment.

While the invention has been described in connection with what is presently considered to be the most practical and preferred embodiments, it is to be understood that the invention is not to be limited to the disclosed embodiments and elements, but, to the contrary, is intended to cover various modifications, combinations of features, equivalent arrangements, and equivalent elements included within the spirit and scope of the appended claims. Furthermore, the dimensions of features of various components that may appear on the drawings are not meant to be limiting, and the size of the components therein can vary from the size that may be portrayed in the figures herein. Thus, it is intended that the present invention covers the modifications and variations of the invention, provided they come within the scope of the appended claims and their equivalents.

1. A quick-loading electrode cartridge for use in an electrocoagulation module, the quick-loading electrode cartridge comprising:
a) a crown member;
b) at least one anode; wherein the at least one anode is secured to the crown;
wherein the quick-loading electrode cartridge substantially fits inside the electrocoagulation module.

2. A quick-loading electrode cartridge as claimed in claim 1 further comprising at least one cathode.

3. A quick-loading electrode cartridge as claimed in claim 2, wherein the at least one anode and at least one cathode are separated by gaps allowing the fluid to circulate as it flows in a generally upwards direction in the electrocoagulation module.

4. A quick-loading electrode cartridge as claimed in claim 2 wherein the at least one anode is semi-cylindrical.

5. A quick-loading electrode cartridge as claimed in claim 2 wherein the at least one anode and at least one cathode are arranged in a substantially concentric manner.

6. A quick-loading electrode cartridge as claimed in claim 1, wherein the cartridge comprises three semi-cylindrical anodes.

7. A quick-loading electrode cartridge as claimed in claim 5, wherein the anodes positioned between an inner cylindrical cathode and an outer cylindrical cathode the cathodes matching the inner and outer shape of the electrocoagulation module.

8. A quick-loading electrode cartridge as claimed in claim 2, wherein the cartridge comprises at least two semi-circular inner electrodes and at least two outer semi-circular electrodes.

9. A quick-loading electrode cartridge as claimed in claim 8, wherein the surface of the at least two inner electrode is smaller than the surface of the at least two outer electrode.

10. A quick-loading electrode cartridge as claimed in claim 8, wherein the at least two semi-circular inner electrode and the at least two outer semi-circular electrodes are anodes.

11. A quick-loading electrode cartridge as claimed in claim 10, wherein the anodes are grouped into two equal sets of semi-cylindrical.

12. A quick-loading electrode cartridge as claimed in claim 2, wherein the anodes are reversibly transformable to cathodes and wherein the cathodes are reversibly transformable to anodes.

13. A quick-loading electrode cartridge as claimed in claim 2, wherein the transformation re of anodes to cathode and vice versa is automatically controlled.

14. A quick-loading electrode cartridge as claimed in claim 2, wherein the electrocoagulation module comprises:
a) an inlet port located at the bottom of the electrocoagulation module;
b) two high temperature switches, wherein a first switch is located at the top of the reactor and a second switch is located at the bottom of the electrocoagulation module;
c) A flow dispersion chamber, wherein the flow dispersion chamber is located above the inlet port.

15. A quick-loading electrode cartridge as claimed in claim 2, wherein, the cartridge further comprises lifting attachment member.

16. A method of using a quick-loading electrode cartridge in a electrocoagulation module, wherein the cartridge comprises a crown member, at least one anode; wherein the at least one anode is secured to the crown and wherein the quick-loading electrode cartridge substantially fits inside the electrocoagulation module. the method comprising:
a) inserting the cartridge in the electrocoagulation module;
b) securing the cartridge to the electrocoagulation module.

17. A method of using quick-loading electrode as claimed in claim 16, wherein the cartridge further comprises at least one cathode.

18. A method of using quick-loading electrode as claimed in claim 17, wherein the method further comprises the steps to:
a) remove the cartridge having at least one anode or one cathode being consumed;
b) replace the removed cartridge with another cartridge.

19. A method of using quick-loading electrode as claimed in claim 18, wherein the method further comprises the step to replace the one or more consumed cartridge with another is replaced by a step to replace the electrodes from the removed cartridge and to replace the cartridge in the electrocoagulation module.
